(19) United States
(12) Patent Application Publication
(10) Pub. No.: US 2023/0367005 A1
(43) Pub. Date: Nov. 16, 2023

(54) METHOD AND APPARATUS FOR PERFORMING BEAM ALIGNMENT ON BASIS OF POSITION IN WIRELESS COMMUNICATION SYSTEM

(71) Applicant: LG ELECTRONICS INC., Seoul (KR)

(72) Inventor: Bong Jun Hwang, Seoul (KR)

(21) Appl. No.: 18/019,202

(22) PCT Filed: Aug. 13, 2021
(86) PCT No.: PCT/KR2021/010811

§ 371 Date: Feb. 1, 2023

(30) Foreign Application Priority Data
Sep. 25, 2020 (KR) 10-2020-0125036
Oct. 6, 2020 (KR) 10-2020-0129018

(51) Int. Cl. G01S 13/931; G01S 13/58; G01S 13/42; G01S 7/00; G01S 7/02

(52) U.S. Cl. CPC G01S 13/931; G01S 13/58; G01S 13/42; G01S 7/006; G01S 7/023; G01S 2013/9316

(57) ABSTRACT

The present disclosure relates to performing beam alignment based on a position in a wireless communication system, and a method for operating a terminal includes generating sequences for chirp signals, mapping complex symbols in the sequences to resource elements (REs) that are allocated for the chirp signals, generating orthogonal frequency division multiplexing (OFDM) symbols including the complex symbols, and transmitting OFDM symbols including the chirp signals, wherein, among the chirp signals, at least some of chirp signals adjacent to each other may overlap on a time axis.

### CROSS-REFERENCE TO RELATED APPLICATIONS

The present application claims priority to PCT Publication No. PCT/KR2021/010811, filed Aug. 13, 2021, which claims priority to Korean patent application 10-2020-0125036, filed Sep. 25, 2020 and a Korean patent application 10-2020-0129018, filed Oct. 6, 2020, the entire contents of which are incorporated herein for all purposes by this reference.

### TECHNICAL FIELD

The present disclosure relates to a wireless communication system and, more particularly, to a method and apparatus for performing beam alignment based on a position in a wireless communication system.

### BACKGROUND

A wireless communication system is a multiple access system that supports communication of multiple users by sharing available system resources (e.g., a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (mMTC), Ultra-Reliable and Low Latency Communication (URLLC), and so on, may be referred to as a new radio access technology (RAT) or new radio (NR). Herein, the NR may also support vehicle-to-everything (V2X) communication.

### SUMMARY

The present disclosure relates to a method and apparatus for effectively performing beam alignment in a wireless communication system.

The present disclosure relates to a method and apparatus for performing beam alignment based on a position of a counterpart terminal in a wireless communication system.

The present disclosure relates to a method and apparatus for determining a range of beam sweeping for beam alignment based on a position of a counterpart terminal in a wireless communication system.

The present disclosure relates to a method and apparatus for generating a frequency modulation continuous wave (FMCW) signal based on orthogonal frequency division multiplexing (OFDM) for estimating a position of a target object in a wireless communication system.

The technical objects to be achieved in the present disclosure are not limited to the above-mentioned technical objects, and other technical objects that are not mentioned may be considered by those skilled in the art through the embodiments described below.

As an example of the present disclosure, a method for operating a terminal in a wireless communication system may include generating sequences for chirp signals, mapping complex symbols in the sequences to resource elements (REs) that are allocated for the chirp signals, generating orthogonal frequency division multiplexing (OFDM) symbols including the complex symbols, and transmitting OFDM symbols including the chirp signals, and adjacent chirp signals of the chirp signals are at least partly overlapped on a time axis.

As an example of the present disclosure, a terminal in a wireless communication system may include a transceiver and a processor coupled to the transceiver. The processor may be configured to generate sequences for chirp signals, to map complex symbols in the sequences to resource elements (REs) that are allocated for the chirp signals, to generate orthogonal frequency division multiplexing (OFDM) symbols including the complex symbols, and to transmit OFDM symbols including the chirp signals, and adjacent chirp signals of the chirp signals are at least partly overlapped on a time axis.

As an example of the present disclosure, a communication device may include at least one processor and at least one computer memory that is coupled to the at least one processor and stores an instruction instructing operations, when executed by the at least one processor. The operations may include generating sequences for chirp signals, mapping complex symbols in the sequences to resource elements (REs) that are allocated for the chirp signals, generating orthogonal frequency division multiplexing (OFDM) symbols including the complex symbols, and transmitting OFDM symbols including the chirp signals, and adjacent chirp signals of the chirp signals are at least partly overlapped on a time axis.

As an example of the present disclosure, a non-transitory computer-readable medium storing at least one instruction may include the at least one instruction that is executable by a processor. The at least one instruction may instruct a device to generate sequences for chirp signals, to map complex symbols in the sequences to resource elements (REs) that are allocated for the chirp signals, to generate orthogonal frequency division multiplexing (OFDM) symbols including the complex symbols, and to transmit OFDM symbols including the chirp signals, and adjacent chirp signals of the chirp signals are at least partly overlapped on a time axis.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, a beam alignment operation may be performed more effectively.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates a structure of a wireless communication system applicable to the present disclosure.

FIG. 2 illustrates a functional division between an NG-RAN and a SGC applicable to the present disclosure.

FIG. 3 illustrates a radio protocol architecture applicable to the present disclosure.

FIG. 4 illustrates a structure of a radio frame in an NR system applicable to the present disclosure.

FIG. 5 illustrates a structure of a slot in an NR frame applicable to the present disclosure.

FIG. 6 illustrates an example of a BWP applicable to the present disclosure.

FIGS. 7A and 7B illustrate a radio protocol architecture for a SL communication applicable to the present disclosure.

FIG. 8 illustrates a synchronization source or synchronization reference of V2X applicable to the present disclosure.

FIGS. 9A and 9B illustrate a procedure of performing V2X or SL communication by a terminal based on a transmission mode applicable to the present disclosure.

FIGS. 10A to 10C illustrate three cast types applicable to the present disclosure.

FIG. 11 illustrates a concept of beam alignment in a wireless communication system according to an embodiment of the present disclosure.

FIG. 12 illustrates an example of a procedure of performing communication based on beam forming in a wireless communication system according to an embodiment of the present disclosure.

FIG. 13A and FIG. 13B illustrate examples of radar signals applicable to the present disclosure.

FIG. 14 illustrates an example of a sampled chirp signal in a wireless communication system according to an embodiment of the present disclosure.

FIG. 15 illustrates an example of resource mapping of symbols constituting a chirp signal in a wireless communication system according to an embodiment of the present disclosure.

FIG. 16 illustrates an example of resource mapping of symbols constituting various chirp signals in a wireless communication system according to an embodiment of the present disclosure.

FIG. 17 illustrates another example of resource mapping of symbols constituting various chirp signals in a wireless communication system according to an embodiment of the present disclosure.

FIG. 18A and FIG. 18B illustrate examples for an interval of chirp signals in a wireless communication system according to an embodiment of the present disclosure.

FIG. 19 illustrates an example of interference between adjacent chirp signals in a wireless communication system according to an embodiment of the present disclosure.

FIG. 20 illustrates a structure of a receiver for processing an adjacent chirp signal in a wireless communication system according to an embodiment of the present disclosure.

FIG. 21 illustrates an example of a procedure of transmitting a radar signal in a wireless communication system according to an embodiment of the present disclosure.

FIG. 22 illustrates an example of a procedure of estimating a position of an object based on a radar signal in a wireless communication system according to an embodiment of the present disclosure.

FIG. 23 illustrates an example of a procedure of performing communication based on a position, which is estimated by using a radar signal, in a wireless communication system according to an embodiment of the present disclosure.

FIG. 24 illustrates a communication system applicable to the present disclosure.

FIG. 25 illustrates wireless devices, in accordance with an embodiment of the present disclosure.

FIG. 26 illustrates a signal process circuit for a transmission signal, in accordance with an embodiment of the present disclosure.

FIG. 27 illustrates a wireless device, in accordance with an embodiment of the present disclosure.

FIG. 28 illustrates a hand-held device, in accordance with an embodiment of the present disclosure.

FIG. 29 illustrates a car or an autonomous vehicle, in accordance with an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”. [55] In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDDCH” may be proposed as an example of the “control information”. In addition, when indicated as “control information (i.e., PDCCH)”, it may also mean that “PDCCH” is proposed as an example of the “control information”.

In the following description, ‘when, if, or in case of’ may be replaced with ‘based on’.

A technical feature described individually in one figure in the present specification may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

For terms and techniques not specifically described among terms and techniques used in the present disclosure, reference may be made to a wireless communication standard document published before the present disclosure is filed. For example, the following document may be referred to.

### (1) 3GPP LTE

3GPP TS 36.211: Physical channels and modulation
3GPP TS 36.212: Multiplexing and channel coding
3GPP TS 36.213: Physical layer procedures
3GPP TS 36.214: Physical layer; Measurements
3GPP TS 36.300: Overall description
3GPP TS 36.304: User Equipment (UE) procedures in idle mode
3GPP TS 36.314: Layer 2—Measurements
3GPP TS 36.321: Medium Access Control (MAC) protocol
3GPP TS 36.322: Radio Link Control (RLC) protocol
3GPP TS 36.323: Packet Data Convergence Protocol (PDCP)
3GPP TS 36.331: Radio Resource Control (RRC) protocol

### (2) 3GPP NR (e.g. 5G)

3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: Overall description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description

### Communication System Applicable to the Present Disclosure

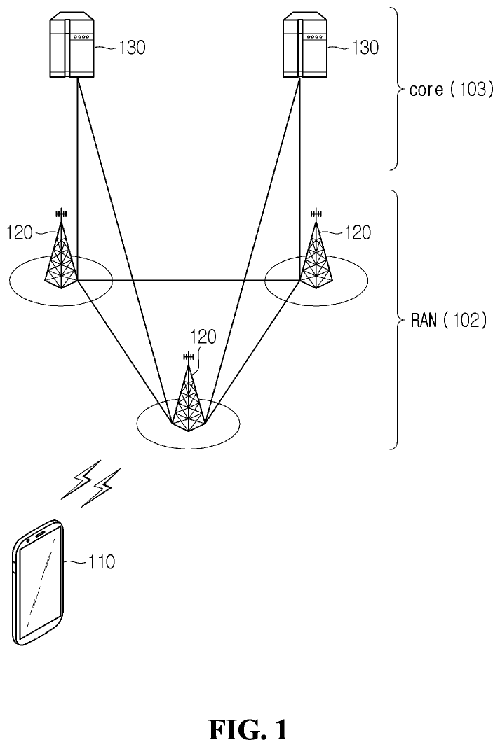

FIG. 1 illustrates a structure of a wireless communication system according to an embodiment of the present disclosure. The embodiment of FIG. 1 may be combined with various embodiments of the present disclosure.

Referring to FIG. 1, a wireless communication system includes a radio access network (RAN) 102 and a core network 103. The radio access network 102 includes a base station 120 that provides a control plane and a user plane to a terminal 110. The terminal 110 may be fixed or mobile, and may be called other terms such as a user equipment (UE), a mobile station (MS), a subscriber station (SS), a mobile subscriber station (MSS), a mobile terminal, an advanced mobile station (AMS), or a wireless device. The base station 120 refers to a node that provides a radio access service to the terminal 110, and may be called other terms such as a fixed station, a Node B, an eNB (eNode B), a gNB (gNode B), an ng-eNB, an advanced base station (ABS), an access point, a base transceiver system (BTS), or an access point (AP). The core network 103 includes a core network entity 130. The core network entity 130 may be defined in various ways according to functions, and may be called other terms such as a core network node, a network node, or a network equipment.

Components of a system may be referred to differently according to an applied system standard. In the case of the LTE or LTE-A standard, the radio access network 102 may be referred to as an Evolved-UMTS Terrestrial Radio Access Network (E-UTRAN), and the core network 103 may be referred to as an evolved packet core (EPC). In this case, the core network 103 includes a Mobility Management Entity (MME), a Serving Gateway (S-GW), and a packet data network-gateway (P-GW). The MME has access information of the terminal or information on the capability of the terminal, and this information is mainly used for mobility management of the terminal. The S-GW is a gateway having an E-UTRAN as an endpoint, and the P-GW is a gateway having a packet data network (PDN) as an endpoint.

In the case of the 5G NR standard, the radio access network 102 may be referred to as an NG-RAN, and the core network 103 may be referred to as a 5GC (5G core). In this case, the core network 103 includes an access and mobility management function (AMF), a user plane function (UPF), and a session management function (SMF). The AMF provides a function for access and mobility management in units of terminals, the UPF performs a function of mutually transmitting data units between an upper data network and the radio access network 102, and the SMF provides a session management function.

The BSs 120 may be connected to one another via Xn interface. The BS 120 may be connected to one another via core network 103 and NG interface. More specifically, the BSs 130 may be connected to an access and mobility management function (AMF) via NG-C interface, and may be connected to a user plane function (UPF) via NG-U interface.

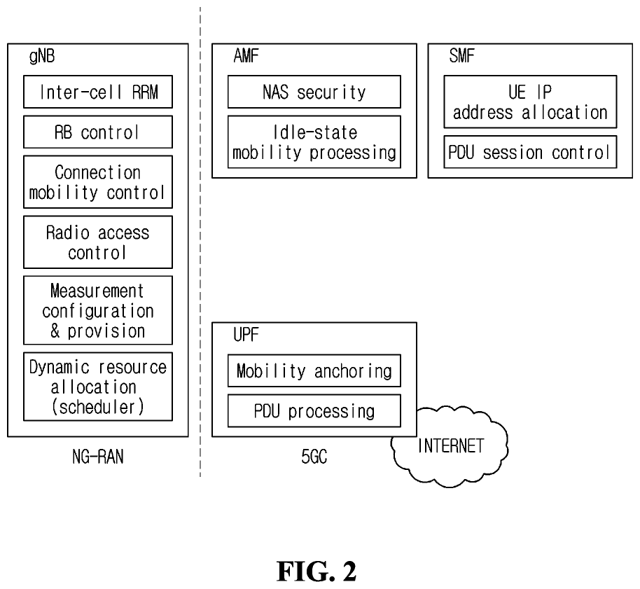

FIG. 2 illustrates a functional division between an NG-RAN and a SGC, in accordance with an embodiment of the present disclosure. The embodiment of FIG. 2 may be combined with various embodiments of the present disclosure.

Referring to FIG. 2, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer enable to exchange an RRC message between the UE and the BS.

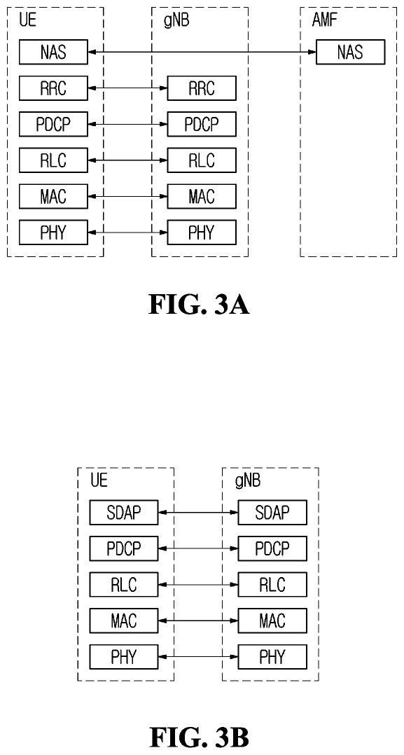

FIGS. 3A and 3B illustrate a radio protocol architecture, in accordance with an embodiment of the present disclosure. The embodiment of FIG. 3 may be combined with various embodiments of the present disclosure. Specifically, FIG. 3A exemplifies a radio protocol architecture for a user plane, and FIG. 3B exemplifies a radio protocol architecture for a control plane. The user plane corresponds to a protocol stack for user data transmission, and the control plane corresponds to a protocol stack for control signal transmission.

Referring to FIGS. 3A and 3B, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PI-TY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

### Radio Resource Structure

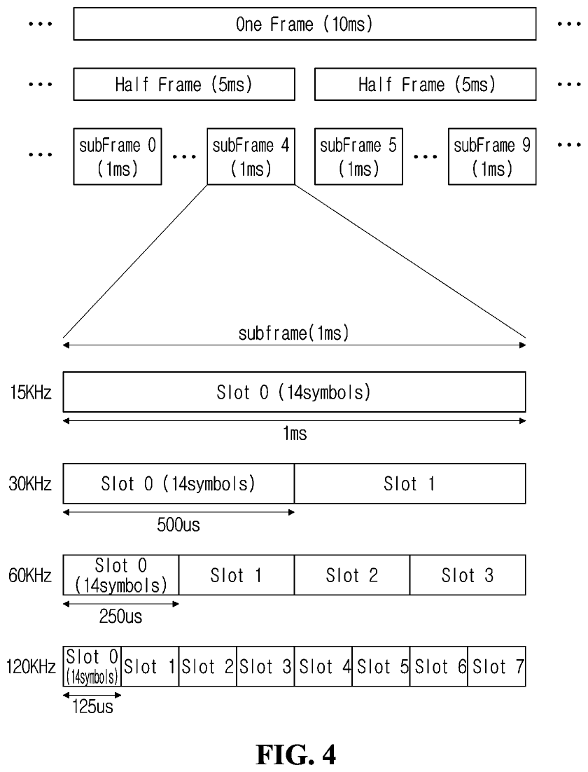

FIG. 4 illustrates a structure of a radio frame in an NR system, in accordance with an embodiment of the present disclosure. The embodiment of FIG. 4 may be combined with various embodiments of the present disclosure.

Referring to FIG. 4, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

In a case where a normal CP is used, a number of symbols per slot (N^{slot}_{symb}), a number slots per frame (N^{frame,μ}ₛₗₒₜ), and a number of slots per subframe (N^{subframe,μ}ₛₗₒₜ) may be varied based on an SCS configuration (μ). For instance, SCS (=15*2^{μ}), N^{slot}_{symb}, N_{frame,μ}^{slot} and N^{subframe,μ}ₛₗₒₜ are 15 KHz, 14, 10 and 1, respectively, when μ=0, are 30 KHz, 14, 20 and 2, respectively, when μ=1, are 60 KHz, 14, 40 and 4, respectively, when μ=2, are 120 KHz, 14, 80 and 8, respectively, when μ=3, or are 240 KHz, 14, 160 and 16, respectively, when μ=4. Meanwhile, in a case where an extended CP is used, SCS (=15*2^{μ}), N^{slot}_{symb}, N^{frame,μ} and N^{subframe,μ} are 60 KHz, 12, 40 and 2, respectively, when μ=2.

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, frequency ranges corresponding to the FR1 and FR2 may be 450 MHz-6000 MHz and 24250 MHz-52600 MHz, respectively. Further, supportable SCSs is 15, 30 and 60 kHz for the FR1 and 60, 120, 240 kHz for the FR2. Among the frequency ranges that are used in an NR system, FR1 may mean a “sub 6 GHz range”, and FR2 may mean an “above 6 GHz range” and may also be referred to as a millimeter wave (mmW).

As described above, the values of the frequency ranges in the NR system may be changed (or varied). For example, comparing to examples for the frequency ranges described above, FR1 may be defined to include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

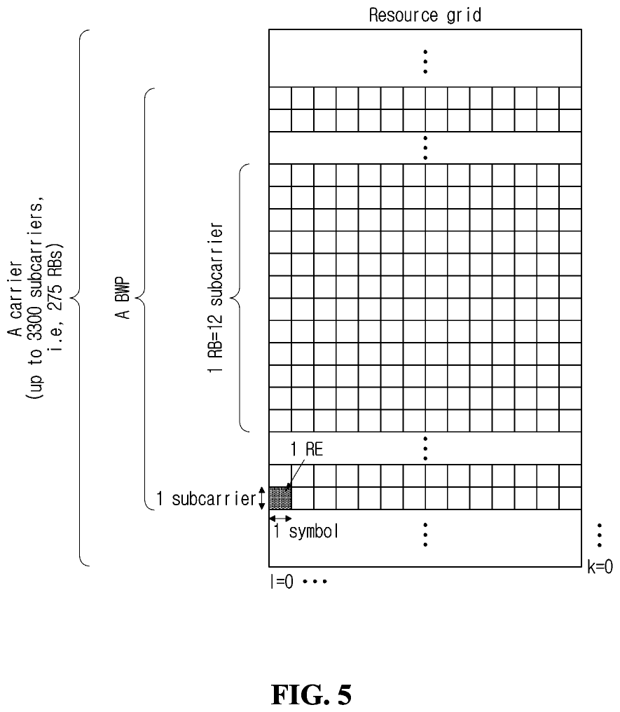

FIG. 5 illustrates a structure of a slot of an NR frame, in accordance with an embodiment of the present disclosure. The embodiment of FIG. 5 may be combined with various embodiments of the present disclosure.

Referring to FIG. 5, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

### Bandwidth Part (BWP)

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit a Physical Uplink Control Channel (PUCCH) or a Physical Uplink Shared Channel (PUSCH) outside an active UL BWP. For example, in a downlink case, the initial BWP may be given as a consecutive RB set for a remaining minimum system information (RMSI) control resource set (CORESET) (configured by PB CH). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

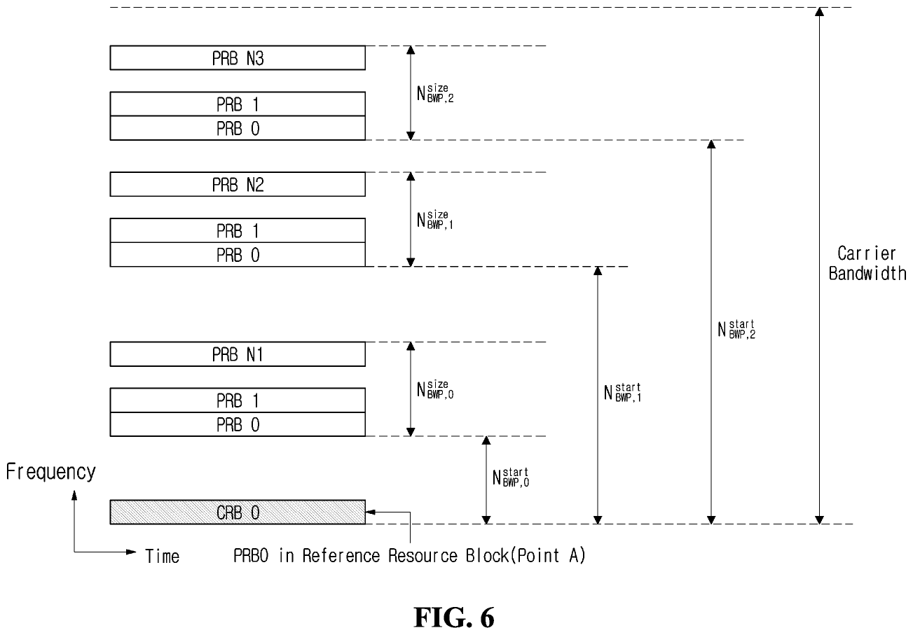

FIG. 6 illustrates an example of a BWP, in accordance with an embodiment of the present disclosure. The embodiment of FIG. 6 may be combined with various embodiments of the present disclosure. It is assumed in the embodiment of FIG. 6 that the number of BWPs is 3.

Referring to FIG. 6, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset (N^{start}_{BWP}) from the point A, and a bandwidth (N^{size}_{BWP}). For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

### V2X or Sidelink Communication

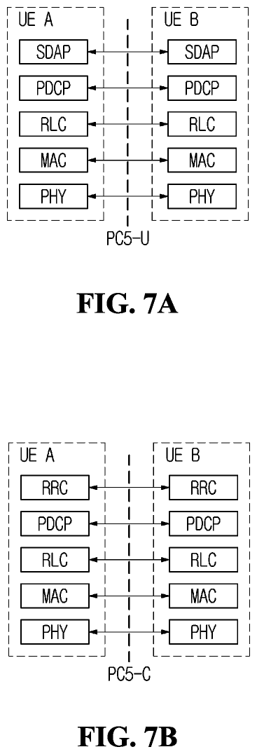

FIGS. 7A and 7B illustrate a radio protocol architecture for a SL communication, in accordance with an embodiment of the present disclosure. The embodiment of FIGS. 7A and 7B may be combined with various embodiments of the present disclosure. More specifically, FIG. 7A exemplifies a user plane protocol stack, and FIG. 7B exemplifies a control plane protocol stack.

### Sidelink Synchronization Signal (SLSS) and Synchronization Information

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-) configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier. For example, based on Table 1, the UE may generate an S-SS/PSBCH block (i.e., S-SSB), and the UE may transmit the S-SS/PSBCH block (i.e., S-SSB) by mapping it on a physical resource.

TABLE 1

| | |
|---|---|
| ▪ | Time-frequency structure of an S-SS/PSBCH block |

In the time domain, an S-SS/PSBCH block consists of N_{symb}^{S-SSB} OFDM symbols, numbered in
increasing order from 0 to N_{symb}^{S-SSB} − 1 within the S-SS/PSBCH block, where S-PSS, S-SSS,
and PSBCH with associated DM-RS are mapped to symbols as given by Table 8.4.3.1-1.
The number of OFDM symbols in an S-SS/PSBCH block N_{symb}^{S-SSB} = 13 for normal cyclic
prefix and N_{symb}^{S-SSB} = 11 for extended cyclic prefix. The first OFDM symbol in an S-
SS/PSBCH block is the first OFDM symbol in the shot.
In the frequency domain, an S-SS/PSBCH block consists of 132 contiguous subcarriers with
the subcarriers numbered in increasing order from 0 to 131 within the sidelink S-
SS/PSBCH block. The quantities k and l represent the frequency and time indices,
respectively, within one sidelink S-SS/PSBCH block.
For an S-SS/PSBCH block, the UE shall use

| | |
|---|---|
| - | antenna port 4000 for transmission of S-PSS, S-SSS, PSBCH and DM-RS for PSBCH; |
| - | the same cyclic prefix length and subcarrier spacing for the S-PSS, S-SSS, PSBCH |
| | and DM-RS for PSBCH. |

Table 8.4.3.1-1: Resources within an S-SS/PSBCH block for S-PSS, S-SSS, PSBCH, and DM-RS.

| | OFDM symbol number l | Subcarrier number k |
|---|---|---|
| Channel | relative to the start of | relative to the start of |
| or signal | an S-SS/PSBCH block | an S-SS/PSBCH block |
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , N_{symb}^{S-SSB} − 1 | 0, 1, . . . , 131 |
| DM-RS for | 0, 5, 6, . . . , N_{symb}^{S-SSB} − 1 | 0, 4, 8, . . . , 128 |
| PSBCH | | |

### Synchroniztion Acquisition of SL Terminal

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

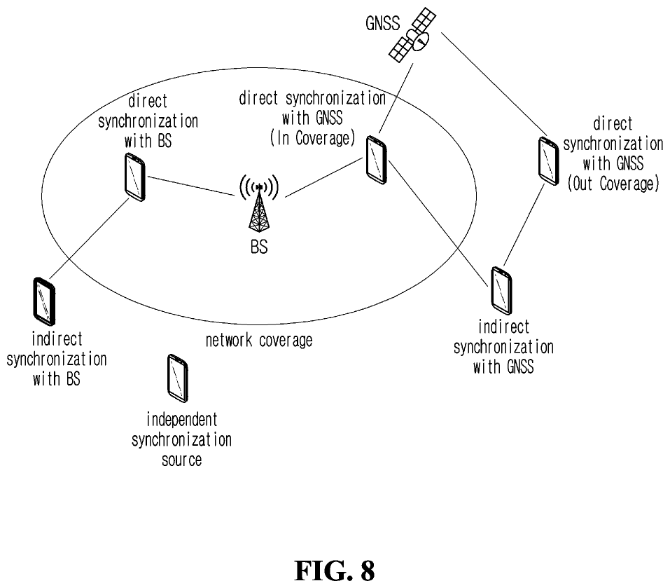

FIG. 8 illustrates a synchronization source or synchronization reference of V2X, in accordance with an embodiment of the present disclosure. The embodiment of FIG. 8 may be combined with various embodiments of the present disclosure.

Referring to FIG. 8, in V2X, a UE may be synchronized with a GNSS directly or indirectly through a UE (within or out of network coverage) directly synchronized with the GNSS. When the GNSS is configured as a synchronization source, the UE may calculate a direct subframe number (DFN) and a subframe number by using a coordinated universal time (UTC) and a (pre)determined DFN offset.

Alternatively, the UE may be synchronized with a BS directly or with another UE which has been time/frequency synchronized with the BS. For example, the BS may be an eNB or a gNB. For example, when the UE is in network coverage, the UE may receive synchronization information provided by the BS and may be directly synchronized with the BS. Thereafter, the UE may provide synchronization information to another neighboring UE. When a BS timing is set as a synchronization reference, the UE may follow a cell associated with a corresponding frequency (when within the cell coverage in the frequency), a primary cell, or a serving cell (when out of cell coverage in the frequency), for synchronization and DL measurement.

The BS (e.g., serving cell) may provide a synchronization configuration for a carrier used for V2X or SL communication. In this case, the UE may follow the synchronization configuration received from the BS. When the UE fails in detecting any cell in the carrier used for the V2X or SL communication and receiving the synchronization configuration from the serving cell, the UE may follow a predetermined synchronization configuration.

Alternatively, the UE may be synchronized with another UE which has not obtained synchronization information directly or indirectly from the BS or GNSS. A synchronization source and a preference may be preset for the UE. Alternatively, the synchronization source and the preference may be configured for the UE by a control message provided by the BS.

An SL synchronization source may be related to a synchronization priority. For example, the relationship between synchronization sources and synchronization priorities may be defined as shown in [Table 2] or [Table 3]. [Table 2] or [Table 3] is merely an example, and the relationship between synchronization sources and synchronization priorities may be defined in various manners.

TABLE 2

| Priority | | |
|---|---|---|
| Level | GNSS-based synchronization | eNB/gNB-based synchronization |
| P0 | GNSS | eNB/gNB |
| P1 | All UEs synchronized | All UEs synchronized |
| | directly with GNSS | directly with NB/gNB |
| P2 | All UEs synchronized | All UEs synchronized |
| | indirectly with GNSS | indirectly with eNB/gNB |
| P3 | All other UEs | GNSS |
| P4 | N/A | All UEs synchronized |
| | | directly with GNSS |
| P5 | N/A | All UEs synchronized |
| | | indirectly with GNSS |
| P6 | N/A | All other UEs |

TABLE 3

| Priority | | |
|---|---|---|
| Level | GNSS-based synchronization | eNB/gNB-based synchronization |
| P0 | GNSS | eNB/gNB |
| P1 | All UEs synchronized | All UEs synchronized |
| | directly with GNSS | directly with eNB/gNB |
| P2 | All UEs synchronized | All UEs synchronized |
| | indirectly with GNSS | indirectly with eNB/gNB |
| P3 | eNB/gNB | GNSS |
| P4 | All UEs synchronized | All UEs synchronized |
| | directly with eNB/gNB | directly with GNSS |
| P5 | All UEs synchronized | All UEs synchronized |
| | indirectly with eNB/gNB | indirectly with GNSS |
| P6 | Remaining UE(s) with | Remaining UE(s) with |
| | lower priority | lower priority |

In [Table 2] or [Table 3], PO may represent a highest priority, and P6 may represent a lowest priority. In [Table 2] or [Table 3], the BS may include at least one of a gNB or an eNB.

Whether to use GNSS-based synchronization or eNB/gNB-based synchronization may be (pre)determined. In a single-carrier operation, the UE may derive its transmission timing from an available synchronization reference with the highest priority.

For example, the UE may (re)select a synchronization reference, and the UE may obtain synchronization from the synchronization reference. In addition, the UE may perform SL communication (e.g., PSCCH/PSSCH transmission/reception, physical sidelink feedback channel (PSFCH) transmission/reception, S-SSB transmission/reception, reference signal transmission/reception, etc.) based on the obtained synchronization.

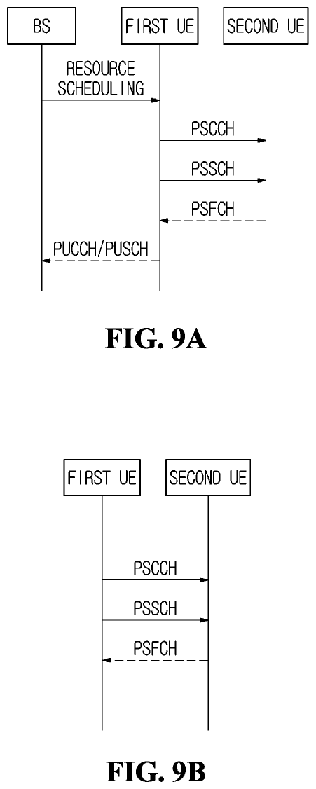

FIGS. 9A and 9B illustrate a procedure of performing V2X or SL communication by a terminal based on a transmission mode, in accordance with an embodiment of the present disclosure. The embodiment of FIGS. 9A and 9B may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 9A exemplifies a UE operation related to an LTE transmission mode 1 or an LTE transmission mode 3. Alternatively, for example, FIG. 9B exemplifies a UE operation related to an NR resource allocation mode 1. For example, the LTE transmission mode 1 may be applied to general SL communication, and the LTE transmission mode 3 may be applied to V2X communication.

For example, FIG. 9B exemplifies a UE operation related to an LTE transmission mode 2 or an LTE transmission mode 4. Alternatively, for example, FIG. 9A exemplifies a UE operation related to an NR resource allocation mode 2.

Referring to FIG. 9A, in the LTE transmission mode 1, the LTE transmission mode 3, or the NR resource allocation mode 1, a BS may schedule an SL resource to be used by the UE for SL transmission. For example, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

Subsequently, the first UE may transmit a PSCCH (e.g., sidelink control information (SCI) or 1^{st}-stage SCI) to a second UE based on the resource scheduling. After then, the first UE may transmit a PSCCH (e.g., 2^{nd}-stage SCI, MAC PDU, data, etc.) related to the PSCCH to the second UE. After then, the first UE may receive a PSFCH related to the PSCCH/PSSCH from the second UE. For example, HARQ feedback information (e.g., NACK information or ACK information) may be received from the second UE through the PSFCH. After then, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling. For example, a format of the DCI may be a DCI format 3_0 or a DCI format 3_1. Table 4 shows an example of a DCI for SL scheduling.

TABLE 4
3GPP TS 38.212

| | |
|---|---|
| ▪ | Format 3_0 |

DCI format 3_0 is used for scheduling of NR PSCCH and NR PSSCH in one cell.
The following information is transmitted by means of the DCI format 3_0 with CRC scrambled
by SL-RNTI or SL-CS-RNTI:

| | - | Resource pool index -┌log₂ I┐ bits, where l is the number of resource pools for |
|---|---|---|
| | | transmission configured by the higher layer parameter sl-TxPoolScheduling. |
| | - | Time gap - 3 bits determined by higher layer parameter sl-DCI-ToSL-Trans, as |
| | | defined in clause 8.1.2.1 of [6, TS 38.214] |
| | - | HARQ process number - 4 bits as defined in clause 16.4 of [5, TS 38.213] |
| | - | New data indicator - 1 bit as defined in clause 16.4 of [5, TS 38.213] |
| | - | Lowest index of the subchannel allocation to the initial transmission -┌log₂(N_{subChannel}^{SL})┐ |
| | | bits as defined in clause 8.1.2.2 of [6, TS 38.214] |
| - | SCI format 1-A fields according to clause 8.3.1.1: | |
| | - | Frequency resource assignment. |
| | - | Time resource assignment. |
| - | PSFCH-to-HARQ feedback timing indicator -┌log₂ N_{fb}_{_{—}}_{timing}┐ bits, where N_{fb}_{_{—}}_{timing} is th [symbol] | |
| | number of entries in the higher layer parameter sl-PSFCH-ToPUCCH, as defined i [symbol] | |
| | clause 16.5 of [5, TS 38.213] | |
| - | PUCCH resource indicator - 3 bits as defined in clause 16.5 of [5, TS 38.213]. | |
| - | Configuration index - 0 bit if the UE is not configured to monitor DCI format 3_0 wit [symbol] | |
| | CRC scrambled by SL-CS-RNTI: otherwise 3 bits as defined in clause 8.1.2 of [6, T [symbol] | |
| | 38.214]. If the UE is configured to monitor DCI format 3_0 with CRC scrambled by SL [symbol] | |
| | CS-RNTI, this field is reserved for DCI format 3_0 with CRC scrambled by SL-RNTI. | |
| - | Counter sidelink assignment index - 2 bits | |
| | - | 2 bits as defined in clause 16.5.2 of [5, TS 38.213] if the UE is configured wit [symbol] |
| | | pdsch-HARQ-ACK-Codebook = dynamic |
| | - | 2 bits as defined in clause 16.5.1 of [5, TS 38.213] if the UE is configured wit [symbol] |
| | | pdsch-HARQ-ACK-Codebook = semi-static |

| | |
|---|---|
| - | Padding bits. if required |
| ▪ | Format 3_1 |

DCI format 3_1 is used for scheduling of LTE PSCCH and LTE PSSCH in one cell.
The following information is transmitted by means of the DCI format 3_1 with CRC scramb [symbol]
by SL-L-CS-RNTI:

| | | |
|---|---|---|
| | - | Timing offset - 3 bits determined by higher layer parameter sl-TimeOffsetEUTRA [symbol] |
| | | defined in clause 16.6 of [5, TS 38.213] |
| | - | Carrier indicator -3 bits as defined in 5.3.3.1.9A of [11, TS 36.212]. |
| | - | Lowest index of the subchannel allocation to the initial transmission - ┌log₂(N_{subchannel}^{SL} [symbol] |
| | | bits as defined in 5.3.3.1.9A of [11, TS 36.212]. |
| | - | Frequency resource location of initial transmission and retransmission, as define [symbol] |
| | | 5.3.3.1.9A of [11, TS 36.212] |
| | - | Time gap between initial transmission and retransmission, as defined in 5.3.3.1.9A [symbol] |
| | | [11, TS 36.212] |
| | - | SL index - 2 bits as defined in 5.3.3.1.9A of [11, TS 36.212] |
| | - | SL SPS configuration index - 3 bits as defined in clause 5.3.3.1.9A of [11, TS 36.21 [symbol] |
| - | | Activation/release indication - 1 bit as defined in clause 5.3.3.1.9A of [11, [symbol] |

36.212]. [symbol]
indicates data missing or illegible when filed

Referring to FIG. 9B, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannel(s). For example, subsequently, a first UE which has selected resource(s) from a resource pool by itself may transmit a PSCCH (e.g., sidelink control information (SCI) or 1^{st}-stage SCI) to a second UE by using the resource(s). After then, the first UE may transmit a PSSCH (e.g., 2^{nd}-stage SCI, MAC PDU, data, etc.) related to the PSCCH to the second UE. In step S8030, the first UE may receive a PSFCH related to the PSCCH/PSSCH from the second UE.

Referring to FIGS. 9A and 9B, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1^{st} SCI, a first SCI, a 1^{st}-stage SCI or a 1^{st}-stage SCI format, and a SCI transmitted through a PSSCH may be referred to as a 2^{nd} SCI, a second SCI, a 2^{nd}-stage SCI or a 2^{nd}-stage SCI format. For example, the 1^{st}-stage SCI format may include a SCI format 1-A, and the 2^{nd}-stage SCI format may include a SCI format 2-A and/or a SCI format 2-B. Table 5 shows an example of a 1^{st}-stage SCI format.

TABLE 5
3GPP TS 38.212

```
SCI format 1-A
SCI format 1-A is used for the scheduling of PSSCH and 2^{nd}-stage-SCI on PSSCH
The following information is transmitted by means of the SCI format 1-A:
  Priority - 3 bits as specified in clause 5.4.3.3 of [12, TS 23.287] and clause 5.22.1.3.1
  of [8, TS 38.321].
  $Frequency resource assignment - ⌈ {log}_{2} ( \frac{{N}_{subChannel}^{SL} ( {N}_{subChannel}^{SL} + 1 )}{2} ) ⌉ bits when the value of$
  the higher layer parameter sl-MaxNumPerReserve is configured to 2; otherwise
  $⌈ {log}_{2} ( \frac{{N}_{subChannel}^{SL} ( {N}_{subChannel}^{SL} + 1 ) ( 2 {N}_{subChannel}^{SL} + 1 )}{5} ) ⌉ bits when the value of the higher layer$
  parameter sl-MaxNumPerReserve is configured to 3, as defined in clause 8.1.2.2 of [6,
  TS 38.214].
  Time resource assignment - 5 bits when the value of the higher layer parameter sl-
  MaxNumPerReserve is configured to 2; otherwise 9 bits when the value of the higher
  layer parameter sl-MaxNumPerReserve is configured to 3, as defined in clause 8.1.2.1
  of [6, TS 38.214].
  Resource reservation period - ┌log₂ Nᵣₛᵥ_{_{—}}_{period}┐ bits as defined in clause 8.1.4 of [6, TS
  38.214], where Nᵣₛᵥ_{_{—}}_{period} is the number of entries in the higher layer parameter sl-
  ResourceReservePeriodList, if higher layer parameter sl-MultiReserveResource is
  configured; 0 bit otherwise.
DMRS pattern - ┌log₂ Nₚₐₜₜₑᵣₙ┐ bits as defined in clause 8.4.1.1.2 of [4, TS 38.211],
where Nₚₐₜₜₑᵣₙ is the number of DMRS patterns configured by higher layer parameter
sl-PSSCH-DMRS-TimePatternList.
2^{nd}-stage SCI format - 2 bits as defined in Table 8.3.1.1-1.
Beta_offset indicator - 2 bits as provided by higher layer parameter sl-
BetaOffsets2ndSCI and Table 8.3.1.1-2.
Number of DMRS port - 1 bit as defined in Table 8.3.1.1-3.
Modulation and coding scheme - 5 bits as defined in clause 8.1.3 of [6, TS 38.214].
Additional MCS table indicator - as defined in clause 8.1.3.1 of [6, TS 38.214]: 1 bit if
one MCS table is configured by higher layer parameter sl-Additional-MCS-Table; 2
bits if two MCS tables are configured by higher layer parameter sl- Additional-MCS-
Tables 0 bit otherwise.
PSFCH overhead indication - 1 bit as defined clause 8.1.3.2 of [6, TS 38.214] if higher
layer parameter sl-PSFCH-Period = 2 or 4; 0 bit otherwise.
Reserved - a number of bits as determined by higher layer parameter sl-
NumReservedBits, with value set to zero.
```

| Table 8.3.1.1-1: 2^{nd}-stage SCI formats | |
|---|---|
| Value of 2nd-stage | |
| SCI format field | 2nd-stage SCI format |
| 00 | SCI format 2-A |
| 01 | SCI format 2-B |
| 10 | Reserved |
| 11 | Reserved |

| Table 8.3.1.1-2: Mapping of Beta_offset indicator values to indexes | |
|---|---|
| in Table 9.3-2 of [5, TS38.213] | |
| Value of Beta_offset | Beta_offset index in Table 9.3-2 of |
| indicator | [5, TS38.213] |
| 00 | 1st index provided by higher layer parameter |
| | sl-BetaOffsets2ndSCI |
| 01 | 2nd index provided by higher layer parameter |
| | sl-BetaOffsets2ndSCI |
| 10 | 3rd index provided by higher layer parameter |
| | sl-BetaOffsets2ndSCI |
| 11 | 4th index provided by higher layer parameter |
| | sl-BetaOffsets2ndSCI |

Table 6 shows an example of a 2^{nd}-stage SCI format.

TABLE 6
3GPP TS 38.212

| | |
|---|---|
| ▪ | SCI format 2-A |

SCI format 2-A is used for the decoding of PSSCH, with HARQ operation when HARQ-ACK
information includes ACK or NACK, when HARQ-ACK information includes only NACK, or
when there is no feedback of HARQ-ACK information.
The following information is transmitted by means of the SCI format 2-A:

| | |
|---|---|
| - | HARQ process number - 4 bits as defined in clause 16.4 of [5, TS 38.213]. |
| - | New data indicator - 1 bit as defined in clause 16.4 of [5, TS 38.213]. |
| - | Redundancy version - 2 bits as defined in clause 16.4 of [6, TS 38.214]. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of [5, TS |
| | 38.213]. |
| - | Cast type indicator - 2 bits as defined in Table 8.4.1.1-1. |
| - | CSI request - 1 bit as defined in clause 8.2.1 of [6, TS 38.214]. |

Table 8.4.1.1-1: Cast type indicator

| Value of Cast | |
|---|---|
| type indicator | Cast type |
| 00 | Broadcast |
| 01 | Groupcast when HARQ-ACK information |
| | includes ACK or NACK |
| 10 | Unicast |
| 11 | Groupcast when HARQ-ACK information |
| | includes only NACK |

| | |
|---|---|
| ▪ | SCI format 2-B |

SCI format 2-B is used for the decoding of PSSCH, with HARQ operation when HARQ-ACK
information includes only NACK, or when there is no feedback of HARQ-ACK information.
The following information is transmitted by means of the SCI format 2-B:

| | |
|---|---|
| - | HARQ process number - 4 bits as defined in clause 16.4 of [5, TS 38.213]. |
| - | New data indicator - 1 bit as defined in clause 16.4 of [5, TS 38.213]. |
| - | Redundancy version - 2 bits as defined in clause 16.4 of [6, TS 38.214]. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of [5, TS |
| | 38.213]. |
| - | Zone ID - 12 bits as defined in clause 5.8.11 of [9, TS 38.331]. |

| | |
|---|---|
| - | Communication range requirement - 4 bits determined by higher layer parameter sl- |

ZoneConfigMCR-index.

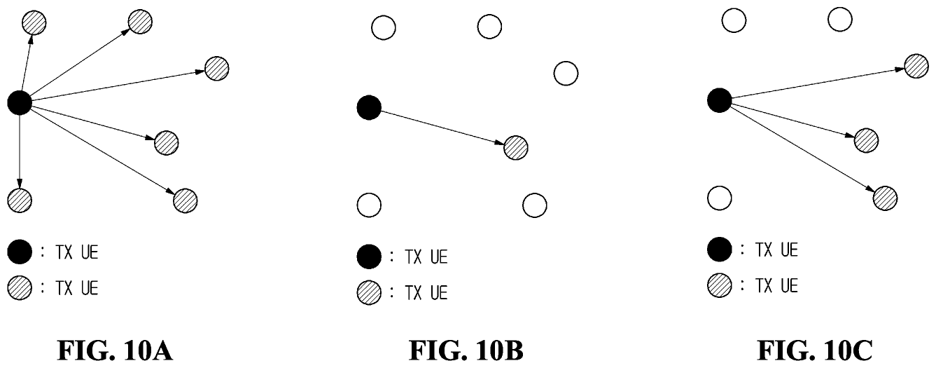

FIGS. 10A to 10C illustrate three cast types applicable to the present disclosure. The embodiment of FIGS. 10A to 10C may be combined with various embodiments of the present disclosure.

Specifically, FIG. 10A exemplifies broadcast-type SL communication, FIG. 10B exemplifies unicast type-SL communication, and FIG. 10C exemplifies groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

### Specific Embodiment of the Present Disclosure

The present disclosure relates to beam alignment in a wireless communication system and to a technique for performing beam alignment more effectively based on a position of a counterpart terminal.

In a millimeter wave (mmWave) V2X communication system, a propagation feature of mmWave with a high path loss needs to be considered. For example, by utilizing a beamforming technique using an array antenna, a system may provide as high a antenna gain as possible. However, in order to obtain a high gain, a beam width should be as small as possible, and thus a beam sweeping time may increase and a time for Tx/Rx beam alignment may increase.

Various techniques for achieving balance between a high gain and fast beam alignment have been proposed, and among the techniques thus introduced, there was a beam alignment technique that utilizes side-information like a position and a situational context. Accordingly, the present disclosure proposes various embodiments where position information (e.g., distance and direction) of a neighbor vehicle is obtained for fast beam alignment and beam alignment is performed based on position information.

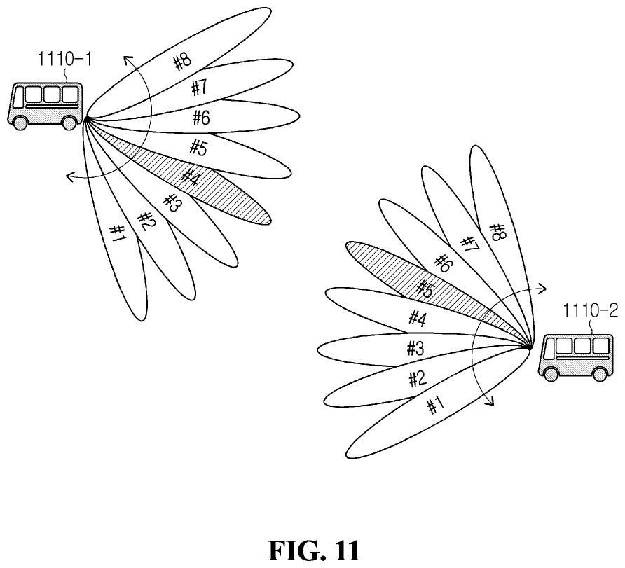

FIG. 11 illustrates a concept of beam alignment in a wireless communication system according to an embodiment of the present disclosure. FIG. 11 exemplifies beam alignment between a first terminal 1110-1 and a second terminal 1110-2. In FIG. 11 below, the first terminal 1110-1 and the second terminal 1110-2 are illustrated to use 8 Tx beams respectively. However, 7 or less beams or 9 or more beams may be used, and furthermore, the first terminal 1110-1 and the second terminal 1110-2 may use different numbers of beams.

Referring to FIG. 11, in order to select a pair of a Tx beam #4 and a Rx beam #5 that provides best channel quality, the first terminal 1110-1 and the second terminal 1110-2 may perform a beam alignment procedure. To this end, the first terminal 1110-1 sweeps 8 Tx beams, and the second terminal 1110-2 sweeps 8 Rx beams. The second terminal 1110-2 may measure channel qualities for respective beam pairs and transmit, to the first terminal 1110-2, information on a Tx beam belonging to a beam pair with a best channel quality or information on timing or a resource where the Tx beam is used.

Through a similar process, an optimal beam pair may be determined for a reverse link, that is, transmission from the second terminal 1110-2 to the first terminal 1110-1. In other words, an optimal beam pair for a Tx beam of the second terminal 1110-2 and a Rx beam of the first terminal 1110-1 may also be determined through a similar process. Alternatively, based on channel reciprocity, a Rx beam responding to an optimal Tx beam and a Tx beam responding to an optimal Rx beam may be used as an optimal beam pair for a reverse link.

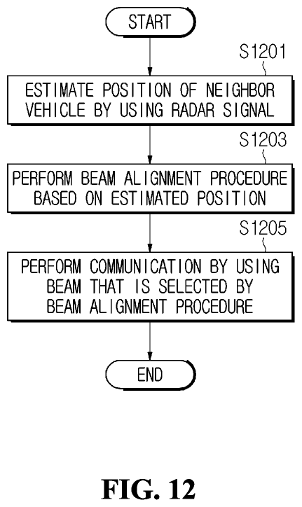

That is, for beam alignment, mutual beam sweeping is required at least once. Herein, when a position of the second terminal 1110-2 cannot be known, the first terminal 1110-1 should sweep beams to cover as many directions as possible. On the other hand, when the first terminal 1110-1 can know a position of the second terminal 1110-2, the first terminal 1110-1 should sweep beams to cover a relatively small number of directions. In other words, when the first terminal 1110-1 can know a position of the second terminal 1110-2, the first terminal 1110-1 may reduce the number of swept beams. In this case, a time required for beam alignment may be reduced. An example of a procedure of performing beam alignment based on a position of a vehicle including a terminal that exist nearby is as in FIG. 12 below.

FIG. 12 illustrates an example of a procedure of performing communication based on beam forming in a wireless communication system according to an embodiment of the present disclosure. FIG. 12 exemplifies a method for operating a terminal (e.g., the first terminal 1110-1) that retrieves a nearby terminal and requests beam alignment.

Referring FIG. 12, at step S1201, a terminal estimates a position of a neighbor vehicle by using a radar signal. That is, before a beam alignment procedure, the terminal may estimate a position for the neighbor vehicle. Thus, a position (e.g., distance, direction, etc.) of at least one neighbor vehicle may be estimated. Herein, required accuracy of position estimation may be suitably designed within a range necessary for determining the number of beams for beam sweeping.

At step S1203, the terminal performs a beam alignment procedure based on the estimated position. The terminal may determine a range of beam sweeping, that is, the number and direction of beams to be swept, based on a position of at least one neighbor vehicle that is discovered by using a radar signal. Herein, the range of beam sweeping may be determined to include a direction of the at least one neighbor vehicle thus discovered.

At step S1205, the terminal performs communication by using a beam that is selected by the beam alignment procedure. Through the beam alignment procedure, the terminal may determine an optimal Tx beam for communication with a terminal included in a neighbor vehicle. Accordingly, the terminal may perform beamforming a signal transmitted to the terminal by using the determined optimal Tx beam.

As described with reference to FIG. 12, before a beam alignment procedure is performed, a position of a neighbor vehicle may be estimated, and the beam alignment procedure may be performed based on the estimated position. There are various techniques for estimating a position, and the present disclosure proposes a scheme of estimating a position by using a 3GPP NR waveform. Specifically, a system according to various embodiments may use radar technology.

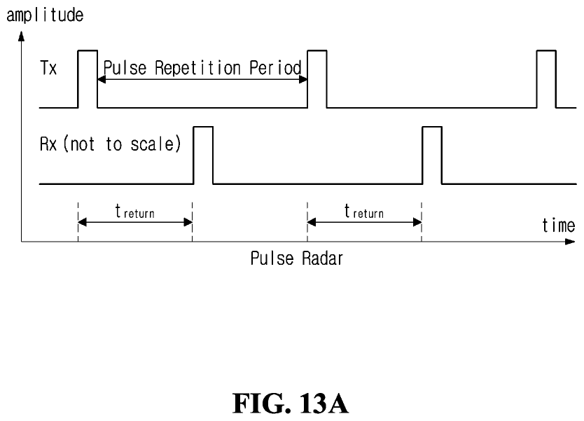

A radar scheme is a detection technique using a predetermined pattern of electromagnetic waves. According to signal forms, radar techniques may be distinguished into pulse radar and frequency modulation continuous wave (FMCW) radar. Signal patterns of each of the schemes are exemplified as in FIG. 13A and FIG. 13B.

FIG. 13A and FIG. 13B illustrate examples of radar signals applicable to the present disclosure. FIG. 13A exemplifies a signal pattern for the pulse radar scheme, and FIG. 13B exemplifies a signal pattern for the FMCW radar scheme.

Referring to FIG. 13A, the pulse radar scheme uses a pulse signal. According to the pulse radar scheme, a device repetitively transmits identical pulse signals at an interval of a pulse repetition period. Accordingly, when pulse signals are reflected in a discovery target and then is received, the device may calculate a return time tretum and estimate a distance to the discovery target based on the return time tretum.

Referring to FIG. 13B, the FMCW scheme uses a chirp signal. According to the FMCW scheme, a device repetitively transmits an identical chirp signal at an interval of a sweep repetition period (SRP). A chirp signal is a continuous signal that has a same power in time axis and has a predetermined slope in frequency axis. That is, a device may generate and transmit chirp signals with a same slope at a predetermined time interval in order to detect a speed for multiple target objects located in a same range.

In FIG. 13B, T_{c} means an interval between adjacent chirp signals, and T_{f} means a length of a single frame including a plurality of chirp signals. Herein, for a moving target object, a velocity resolution Vᵣₑₛ of radar is λ/2T_{f}, and a maximum measurable velocity Vₘₐₓ of radar is λ/4T_{c}.

When the two radar schemes described above are compared, the FMCW radar scheme shows relatively better performance with respect to short range target detection, visibility of close in target, and target resolution in range. The pulse scheme shows relatively better performance with respect to long range target detection, vulnerability to interference from other radars, and vulnerability to onboard reflectors.

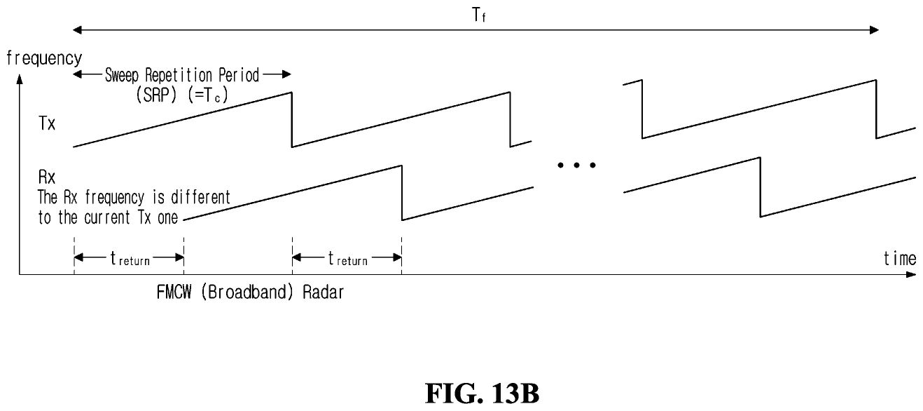

One of the two above-described radar schemes may be adopted in a system according to various embodiments. Hereinafter, embodiments using the FMCW scheme will be described. Specifically, the present disclosure proposes a sampled FWCM reference signal pattern for implementing the FMCW scheme in an OFDM resource grid. In order to implement an FMCW based on an OFDM waveform, a transmitter according to various embodiments generates a sampled chirp signal in OFDM sub-carrier units as shown in FIG. 14.

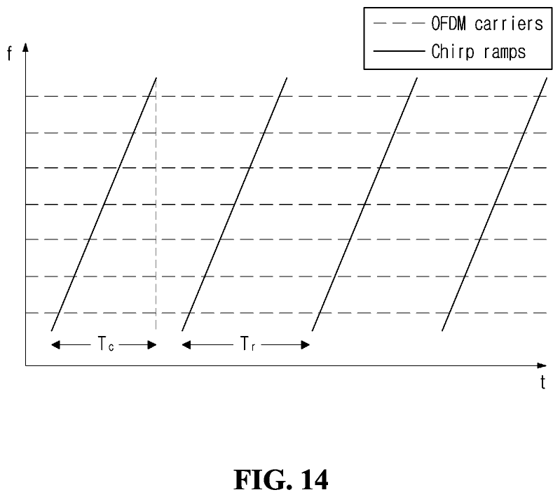

FIG. 14 illustrates an example of a sampled chirp signal in a wireless communication system according to an embodiment of the present disclosure. Referring to FIG. 14, chirp signals with a T_{c} length are arranged at an interval of Tᵣ, and complex symbols, which are sampled in sub-carrier units, constitute each chirp signal. Hereinafter, concrete examples of OFDM-based chirp signals will be described with reference to FIGS. 15 to 17.

FIG. 15 illustrates an example of resource mapping of symbols constituting a chirp signal in a wireless communication system according to an embodiment of the present disclosure. Referring to FIG. 15, a vertical axis means frequency, and a horizontal axis means time. FIG. 15 illustrates 6 resource blocks (RBs), but one chirp signal may be mapped to 7 or more (e.g. 12) RBs. Referring to FIG. 15, each symbol on the time axis and one sub-carrier per RB on the frequency axis are allocated for symbols 1511 to 1516 constituting a chirp signal. When following such a structure as shown in FIG. 15, main performance indicators of radar according to numerology are as in Table 7 below.

TABLE 7

| | | | | |
|---|---|---|---|---|
| SCS [kHz] | 60 | 120 | 240 | 480 |
| BW [MHz] | 8.64 | 17.28 | 36.56 | 69.12 |
| Dᵣₑₛ [m] | 17.36 | 8.68 | 4.34 | 2.17 |
| Vₘₐₓ [km/h] | 17 | 34 | 69 | 137 |
| Vᵣₑₛ [km/h] | 3 | 6 | 11 | 23 |

In Table 7, BW means bandwidth, Dᵣₑₛ means distance resolution, Vₘₐₓ means a maximum measurable velocity for a moving target object, and Vᵣₑₛ means velocity resolution for a moving target object. As described above, radar performance may be different according to SCS. Herein, even when SCS is maintained, as the number of RBs being used increases, bandwidth may increase and thus Dᵣₑₛ performance may be improved. Accordingly, depending on a determination based on control of a base station or a communication environment, a terminal may determine and apply a resource configuration (e.g., SCS) suitable for required radar performance. In consideration of various V2X application scenarios, when SCS is equal to or greater than 240 KHz, sufficient performance as radar may be secured.

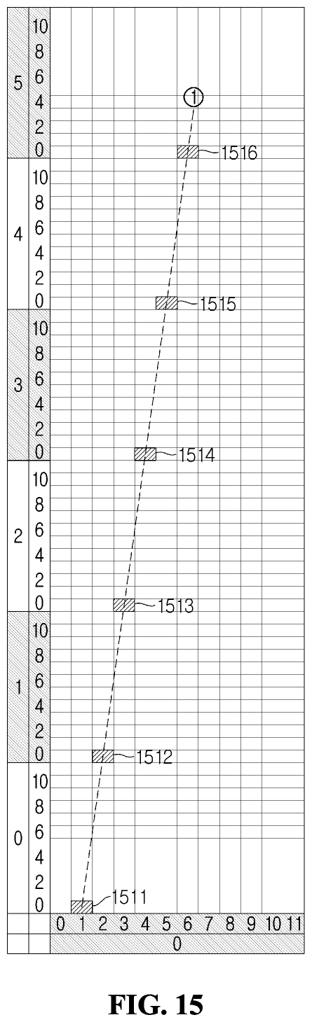

FIG. 16 illustrates an example of resource mapping of symbols constituting various chirp signals in a wireless communication system according to an embodiment of the present disclosure. FIG. 16 exemplifies the chirp signal exemplified in FIG. 15 and chirp signals with a different slope.

Referring to FIG. 16, chirp signals exemplified herein are as follows: a first chirp signal 1610 consisting of a symbol line including symbols 1601, 1612, 1613, 1614, 1615 and 1616, a second chirp signal 1620 consisting of a symbol line including symbols 1601, 1622, 1623, 1624, 1625 and 1626, a third chirp signal 1630 consisting of a symbol line including symbols 1601, 1632, 1633, 1635 and 1636, and a fourth chirp signal 1640 consisting of a symbol line including symbols 1601, 1642, 1643, 1644, 1645 and 1646. For each of the chirp signals 1610, 1620, 1630 and 1640, one RE per RB is allocated along the frequency axis. As exemplified in FIG. 16, symbol lines constituting the chirp signals 1610, 1620, 1630 and 1640 respectively include 6 symbols, but 7 or more (e.g., 12) symbols may be included. In case SCS is 240 KHz and each of the chirp signals 1610, 1620, 1630 and 1640 consists of 12 symbols, radar performance may be compared as in Table 8 below.

TABLE 8

| | First | Second | Third | Fourth |
|---|---|---|---|---|
| | chirp | chirp | chirp | chirp |
| | signal | signal | signal | signal |
| Number of RBs | 12 | 12 | 12 | 12 |
| Number of symbols | 12 | 24 | 36 | 48 |
| Number of chirp | 12 | 6 | 4 | 3 |
| signals (12 slots) | | | | |
| Dᵣₑₛ [m] | 4.34 | 4.34 | 4.34 | 4.34 |
| Vₘₐₓ [km/h] | 69.00 | 34.29 | 22.86 | 17.14 |
| Vᵣₑₛ [km/h] | 11.43 | 11.43 | 11.43 | 11.43 |

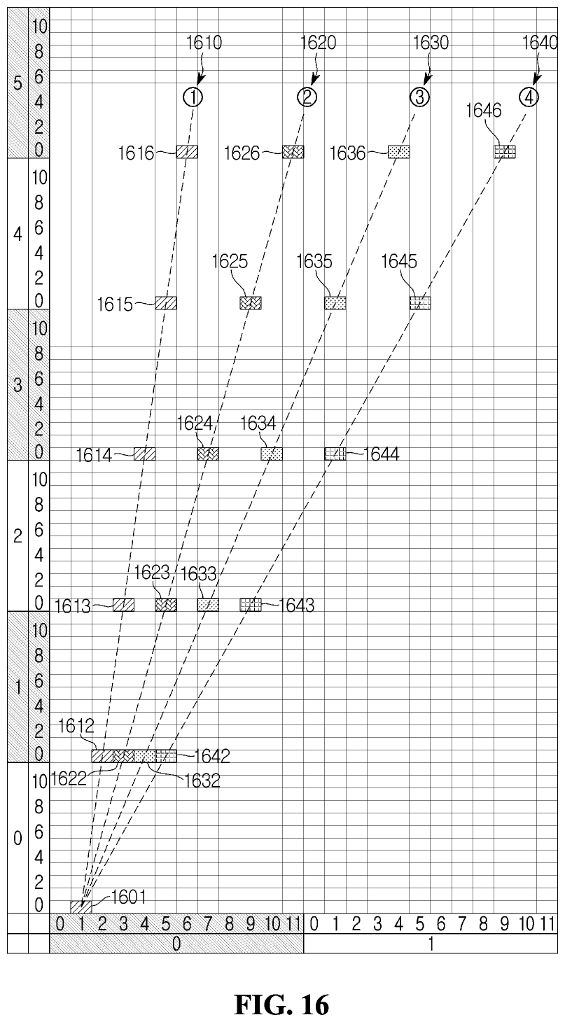

In Table 8, for chirp signals, it is assumed that 12 RBs and 12 slots are used as a same amount of resources. Thus, the 4 cases have different numbers of continuous chirp signals. Referring to Table 8, Dᵣₑₛ is the same in every case. It is because all the above chirp signals use 12 RBs and thus have a same bandwidth. On the other hand, Vₘₐₓ is different in each case. Vₘₐₓ is highest in the case of the first chirp signal 1610. It is because Vₘₐₓ performance is improved by using closely spaced multi chirp, that is, Vₘₐₓ is inversely proportional to a length of time domain between adjacent chirp signals. When operating a chirp signal, in order to increase Vₘₐₓ, a sufficient number of samples constituting a chirp signal needs to be secured. Accordingly, as in FIG. 17, based on difference in the number of samples according to a slope that can be expressed in a resource grid, a chirp signal utilizing expressible samples may be used.

FIG. 17 illustrates another example of resource mapping of symbols constituting various chirp signals in a wireless communication system according to an embodiment of the present disclosure. Referring to FIG. 17, chirp signals with different slopes, that is, a first chirp signal 1710, a second chirp signal 1720, a third chirp signal 1730, a fourth chirp signal 1740, a fifth chirp signal 1750, and a sixth chirp signal 1760 may be defined. Herein, according to slopes, the number of samples constituting the chirp signals 1710, 1720, 1730, 1740, 1750 and 1760, that is, the number of symbols may be different. For example, the first chirp signal 1710 may be configured by one symbol per RB, and the second chirp signal 1720 may be configured by one symbol per RB. That is, as a slope becomes smaller, the number of symbols per RB increases. However, in this case, when a chirp signal has a small slope, the doppler measurement according to a movement of a target object may be restricted. Accordingly, it is desirable that a structure as in FIG. 17 should be limited to radar only for object detection, not for measurement of velocity of a target object.

In case patterns of the chirp signals 1710, 1720, 1730, 1740, 1750 and 1760 with six different slopes, as exemplified in FIG. 17, have a bandwidth of 12-RB, radar performance may be compared as in Table 9 below.

TABLE 9

| | First | Second | Third | Fourth | Fifth | Sixth |
|---|---|---|---|---|---|---|
| | chirp | chirp | chirp | chirp | chirp | chirp |
| | signal | signal | signal | signal | signal | signal |
| Number of RBs | 12 | 12 | 12 | 12 | 12 | 12 |
| Number of symbols | 12 | 24 | 36 | 48 | 72 | 144 |
| Number of chirp | 12 | 6 | 4 | 3 | 2 | 1 |
| signals (12 slots) | | | | | | |
| Dᵣₑₛ [m] | 4.34 | 4.34 | 4.34 | 4.34 | 4.34 | 4.34 |
| Vₘₐₓ [km/h] | 69.00 | 34.29 | 22.86 | 17.14 | 11.43 | 5.71 |
| Vᵣₑₛ [km/h] | 11.43 | 11.43 | 11.43 | 11.43 | 11.43 | 11.43 |

Referring to Table 9, Vₘₐₓ performance varies according to different patterns of chirp signals. Specifically, a chirp signal consisting of 12 symbols may have best doppler detection performance.

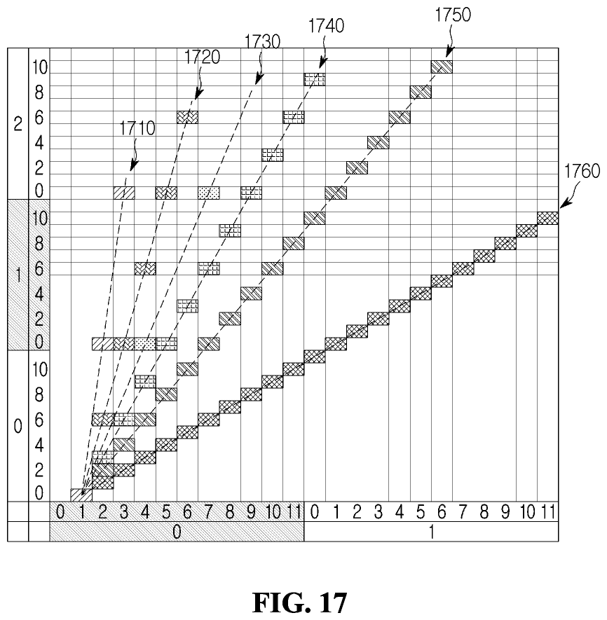

In the FMCW radar scheme, in order to achieve Vₘₐₓ performance of 100 to 200 km/h, a T_{c} of approximately 20 to 40 us is required. However, in the case of a frame structure using an extended cyclic prefix (CP) of the current 3GPP 5G NR, it is not easy to realize a T_{c} of approximately 20 to 40 us with no overlap between adjacent chirp signals. Accordingly, the present disclosure proposes a method of implementing a chirp signal frame that allows an overlap of adjacent chirp signals as shown in FIG. 18B below.

FIG. 18A and FIG. 18B illustrate examples for an interval of chirp signals in a wireless communication system according to an embodiment of the present disclosure. FIG. 18A exemplifies a chirp signal frame with no overlap between adjacent chirp signals, and FIG. 18B exemplifies a chirp signal frame exemplifies a chirp signal frame with no overlap between adjacent chirp signals. In the case of FIG. 18A, an interval T_{c} between adjacent chirp signals is equal to or greater than a time duration of a single chirp signal. On the other hand, in the case of FIG. 18B, an interval Sub-T_{c} between adjacent chirp signals is smaller than a time duration of a single chirp signal.

In the case of a chirp signal that is not based on an OFDM waveform, there is no method of distinguishing overlapped chirp signals. However, in the case of a chirp signal based on an OFDM waveform according to various embodiments, a pseudo-random sequence with good cross-correlation may be used as a sequence constituting the chirp signal. In this case, chirp signals have orthogonality that enables them to be distinguished from each other. Accordingly, even when adjacent chirp signals have a sub-T_{c} interval smaller than an T_{c} interval that enables an arrangement without overlap, an overlapped sampled chirp signal may be allowed as shown in FIG. 18B.

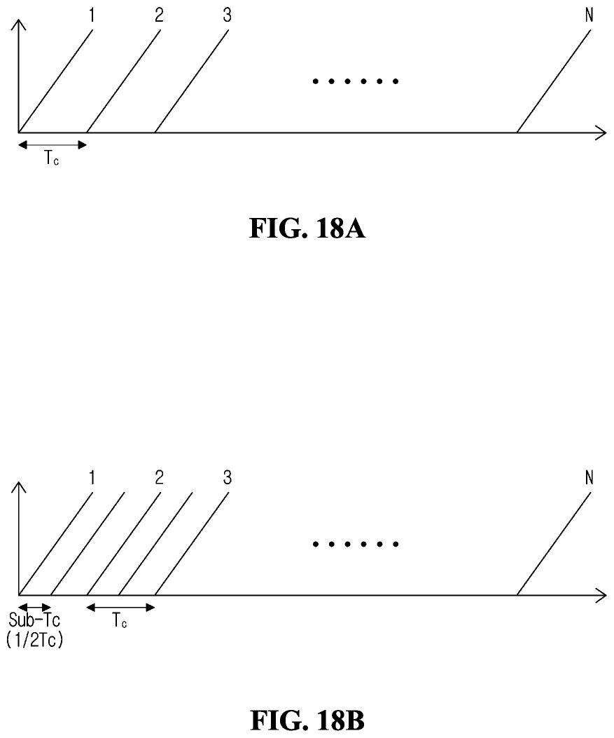

FIG. 19 illustrates an example of interference between adjacent chirp signals in a wireless communication system according to an embodiment of the present disclosure. FIG. 19 exemplifies an interference phenomenon caused by a Rx signal responding to an adjacent chirp signal, when sequences are arranged based on a sub-T_{c} that is smaller than an interval Tₜhat enables an arrangement without overlap between adjacent chirp signals.

Referring to FIG. 19, a device transmits a first chirp signal 1902a and a second chirp signal 1904a. Herein, the second chirp signal 1904a is transmitted before a time period of the first chirp signal 1902a ends. That is, the front of the second chirp signal 1904a overlaps with the end of the first chirp signal 1902a on the time axis. After the first chirp signal 1902a transmitted by the device is reflected in an object, a reflected signal 1902b is received by the device. Similarly, a reflected signal 1904b responding to the second chirp signal 1904a, which is transmitted by the device, is received by the device. As the first chirp signal 1902a and the second chirp signal 1904a overlap with each other, the end of the reflected signal 1902b overlaps with the front 1903 of the reflected signal 1904b, and this may function as interference.

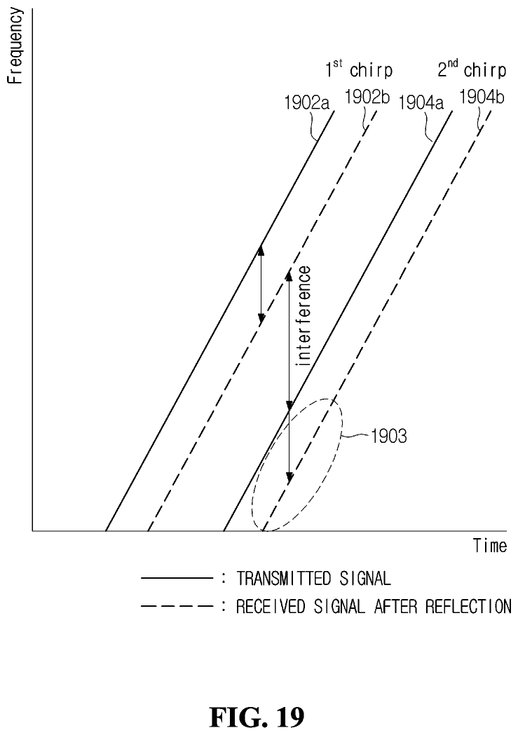

Accordingly, an interference cancellation operation may be performed during an object detection process using a chirp signal. In other words, in order to cancel interference caused by an adjacent chirp signal during a process of mixing a Rx chirp signal sequence to be measured, a device may perform an operation of interference cancellation during a process of signal processing. To this end, an example of a receiver structure is as in FIG. 20 below.

FIG. 20 illustrates a structure of a receiver for processing an adjacent chirp signal in a wireless communication system according to an embodiment of the present disclosure. FIG. 20 exemplifies a structure of a receiving circuit for a device, which transmits a chirp signal, to process a chirp signal that is received after being reflected in an object.

Referring to FIG. 20, a receiver includes a local oscillator 2002, a mixer 2004, a low pass filter (LPF) 2006, an analog to digital converter (ADC) 2008, a CP remover 2010, an FFT calculator 2012, an interference canceller 2014, and a position detector 2016.

The local oscillator 2002 and the mixer 2004 convert a received signal to a signal in a relatively low frequency band (e.g., midband or baseband). Specifically, the local oscillator 2002 generates a frequency signal corresponding to a target frequency band, and the mixer 2004 multiplies a received signal and the frequency signal. Herein, the received signal includes a plurality of reflected chirp signals, that is, echo signals.

The LPF 2006 passes only a low-frequency component among signals output from the mixer 2004, for example, only a baseband component. The ADC 2008 converts a baseband signal filtered by the LPF 2006 into a digital signal. The CP remover 2010 divides a signal in a unit of OFDM symbol and removes CP. The FFT calculator 2012 obtains symbols per sub-carrier by performing FFT operation for an OFDM symbol with CP being removed. Thus, the receiver may obtain symbol sequences constituting echo signals. Herein, the echo signals have a sampled form.

The interference canceller 2014 cancels interference between echo signals that are adjacent to each other. As chirp signals consist of sequences that are designed to be orthogonal, the interference canceller 2014 may cancel interference between the signals by using orthogonality of the sequences. Thus, the receiver may obtain echo signals without interference between them or similar echo signals.

The position detector 2016 detects a position of an object, for example, a neighbor vehicle by using chirp signals with interference being cancelled. Specifically, the position detector 2016 may estimate a distance to an object based on a frequency difference between a received chirp signal and a reference. For example, the reference may be a frequency of a transmitted chirp signal. Herein, the frequency difference may be understood as a frequency difference between samples that are transmitted and received respectively at a same time.

In case an object moves with a velocity, a received signal may undergo doppler shift. In order to detect doppler shift, the position detector 2016 may compare samples with a lowest frequency and samples with a highest frequency for a transmitted chirp signal and a received echo signal. For example, when a lowest frequency of a sample of a received echo signal is lower than a lowest frequency of a sample of a transmitted chirp signal, the position detector 2016 may be determined to move closer to an object. Herein, as the frequency difference between samples with lowest frequencies increases, an object will be determined to have a faster velocity.

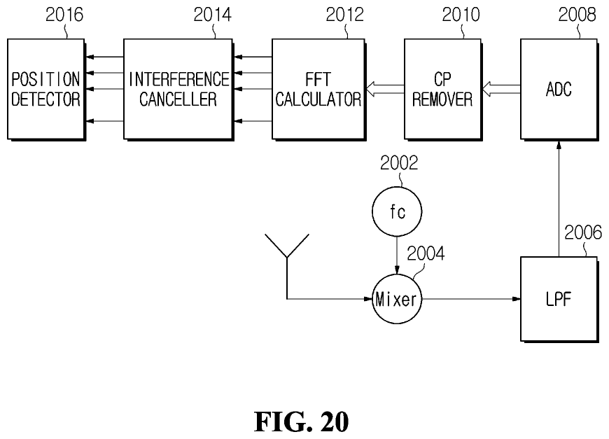

FIG. 21 illustrates an example of a procedure of transmitting a radar signal in a wireless communication system according to an embodiment of the present disclosure. FIG. 21 exemplifies a method for operating a terminal (e.g., the first terminal 1110-1) that retrieves a nearby terminal and requests beam alignment.

Referring to FIG. 21, at step S2101, a terminal generates sequences for chirp signals. In other words, the terminal generates the sequences constituting chirp signals. Herein, a single sequence may be repetitively used, or a plurality of sequences may be sequentially repeated. According to various embodiments, even when at least some of adjacent chirp signals are overlapped, the terminal may generate orthogonal or quasi-orthogonal sequences to enable the chirp signals to be separated from each other. A rule for generating sequences may be defined in advance, or sequence values may be stored in a pre-calculated form.

At step S2103, the terminal maps complex symbols constituting sequences to REs that are allocated for chirp signals. Samples constituting each sequence may be understood as complex symbols that can be mapped to an OFDM grid. Accordingly, similar to mapping a modulation symbol, the terminal may map complex symbols constituting sequences to REs. REs, which are allocated for a single chirp signal, include a RE set that is arranged at a predetermined interval on a frequency axis and a time axis, and since a plurality of chirp signals is transmitted, a plurality of RE sets may be arranged at an equal interval on the time axis. Herein, in a single RE set, the number of REs allocated per RB may be determined based on a configuration associated with a chirp signal. For example, REs, which are allocated for chirp signals, may include at least one of shaded REs in FIG. 15, FIG. 16 and FIG. 17.

At step S2105, the terminal generates OFDM symbols including RE-mapped complex symbols. That is, the terminal generates the OFDM symbols by performing an IFFT operation and adding a cyclic prefix (CP). Herein, other REs than a RE mapped with the chirp signal may be used for another purpose. For example, the terminal may map a data symbol to at least some of the other REs. As another example, the terminal may map no signal to the other REs (e.g., 0 value mapping).

At step S2107, the terminal transmits the OFDM symbols including the chirp signals through a resource that is allocated to detect a position of a neighbor vehicle. A resource for transmitted a chirp signal may be configured, and information on the configured resource may be signaled from a base station in advance. According to an embodiment, the resource may be allocated in such a form as resource pool, and information on a configured resource may indicate a position of the resource pool (e.g., offset, period, duration). According to another embodiment, a bandwidth part (BWP) for transmitting chirp signals may be allocated.

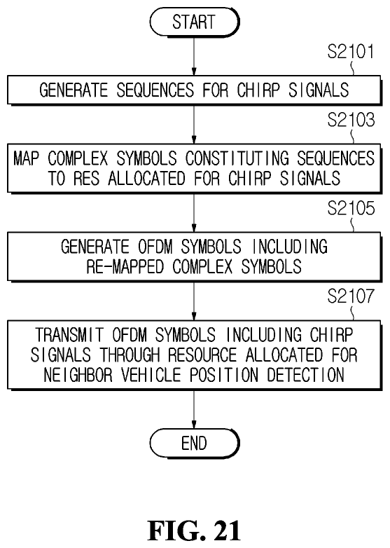

FIG. 22 illustrates an example of a procedure of estimating a position of an object based on a radar signal in a wireless communication system according to an embodiment of the present disclosure. FIG. 22 exemplifies a method for operating a terminal (e.g., the first terminal 1110-1) that retrieves a nearby terminal and requests beam alignment.

Referring to FIG. 22, at step S2201, a terminal receives reflected chirp signals. Since chirp signals are transmitted as a part of OFDM symbols after RE mapping, the reflected chirp signals, that is, echo signals are also received as a part of the OFDM symbols. Accordingly, the terminal may generate complex symbols for each sub-carrier through an FFT operation for a received signal. Herein, processing of OFDM symbols, including the FFT operation, may be performed while OFDM symbols including chirp signals are transmitted.

At step S2203, the terminal cancels interference between adjacent chirp signals. Since the chirp signals consist of orthogonal or quasi-orthogonal sequences, the terminal may cancel the interference between the chirp signals by using orthogonality or quasi-orthogonality. Thus, the terminal may obtain an effect of transmitting chirp signals like those transmitted without overlap, while maintaining a bandwidth of the chirp signals.

At step S2205, the terminal detects a position of a neighbor vehicle based on the chirp signals. The terminal may estimate a distance to the neighbor vehicle based on a frequency difference at a same time or a time difference of a same sample between transmitted chirp signals and reflected echo signals. In addition, the terminal may estimate a movement direction and a velocity of the neighbor vehicle based on doppler shift underwent by an echo signal.

In the case of the above-described radar using a chirp signal, when an existing FMCW signal is applied, there occurs interference with another chirp signal nearby using a same scheme. Accordingly, the present disclosure proposes a method of reducing interference between signals by generating a unique sequence of each terminal and generating an independent chirp signal sample. For example, a first sample of each chirp signal corresponds to r(0) of a sequence determined as in Equation 1 below, and a continuous sequence after r(0) is allocated for a same chirp signal.

$$r ( m ) = \frac{1}{\sqrt{2}} ( 1 - 2 c ( 2 m ) ) + j \frac{1}{\sqrt{2}} ( 1 - 2 ( 2 m + 1 ) ) \qquad Equation 1$$

In Equation 1, r(m) means a value of an m-th sample of a sequence, and c(i) means a pseudo-random sequence. For example, a pseudo-random sequence may be applied in a same manner as a sequence defined in Clause 5.2.1 of the specification 3GPP TS 38.311, and a seed value cᵢₙᵢₜ for the pseudo-random sequence may be defined as in Equation 2.

cᵢₙᵢₜ=(2¹⁷(N_{symb}^{slot}n_{s,f}^{μ}++1)(2n_{ID}+1)+n_{ID})mod2³¹ Equation 2

In Equation 2, cᵢₙᵢₜ means a seed value,N_{symb}^{slot} means the number of symbols per slot, n_{s,f}^{μ} means a slot number in a wireless frame, [symbol] means an OFDM symbol number in a slot, and n_{ID} means an upper layer parameter.

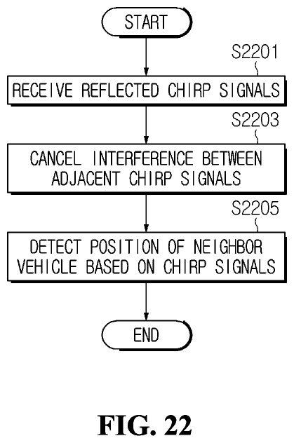

FIG. 23 illustrates an example of a procedure of performing communication based on a position, which is estimated by using a radar signal, in a wireless communication system according to an embodiment of the present disclosure. FIG. 23 exemplifies a method for operating a terminal (e.g., the first terminal 1110-1) that retrieves a nearby terminal and requests beam alignment.

Referring to FIG. 23, at step S2301, a terminal estimates a position of a neighbor vehicle based on an OFDM-based radar signal. The terminal may transmit OFDM symbols including chirp signals consisting of orthogonal or quasi-orthogonal sequences and estimate a position (e.g., direction, distance, moving velocity, etc.) of at least one neighbor vehicle based on the transmitted chirp signals and echo signals that are received after being reflected.

At step S2303, the terminal determines a beam sweeping range based on the estimated position. That is, the terminal may determine a beam sweeping range for beam alignment based on the estimated position, particularly, based on a direction. In case a position of a single neighbor vehicle is identified, the terminal may determine to perform beam sweeping within a range including a predetermined angle around the position of the neighbor vehicle or within a range including a predetermined number of beams. In case positions of a plurality of neighbor vehicles are identified, the terminal may determine a beam sweeping range to cover only one of the plurality of neighbor vehicles or determine a beam sweeping range to cover all of the plurality of neighbor vehicles.

At step S2305, the terminal transmits request signals by using a plurality of Tx beams within the determined range. That is, a request signal is repetitively transmitted by using beams with different directions. The request signals are signals that trigger beam alignment. Each of the request signals may include at least one of a synchronization signal, a broadcast signal, a discovery signal, and a reference signal. Alternatively, each of the request signals may include at least one of a discovery signal and a reference signal, and a separate synchronization signal and a separate broadcast signal may be transmitted.

At step S2307, the terminal receives at least one response signal. The response signal indicates one signal among request signals, and the terminal may accordingly determine a Tx beam selected by a terminal included in a neighbor vehicle. The response signal may be received through a resource corresponding to the request signals.

According to the various embodiments described above, a terminal may estimate a position of a neighbor vehicle by employing OFDM-based chirp signals and effectively perform beam alignment. Herein, when including a chirp signal in an OFDM symbol, various RE allocations are possible. For example, as in FIG. 16, a slope of a chirp signal may be implemented in various ways. In addition, as in FIG. 17, the number of REs for a chirp signal (e.g., the number of REs per RB) may be selected in various ways. Radar performance and characteristics may be different according to a slope on a time-frequency grid of a chirp signal and the number of Res.

Accordingly, according to an embodiment, a terminal may detect a communication environment and determine a configuration (e.g., a slope, the number of REs) of a chirp signal according to the communication environment. For example, communication environments may be divided into highway environment, general road environment and the like, and a terminal in this case may determine a communication environment according to its moving velocity and position. According to another embodiment, a communication environment may be detected by a base station, and a terminal may determine a configuration of a chirp signal according to signaling from the base station.

### System and Various Devices to Which Embodiments of the Present Disclosure are Applicable

Various embodiments of the present disclosure may be combined with each other.

Hereinafter, a device to which various embodiments of the present disclosure may be applied will be described. Although not limited thereto, various descriptions, functions, procedures, proposals, methods, and/or operation flowcharts disclosed in this document may be applied to various fields requiring wireless communication/connection (e.g., 5G) between devices.

Hereinafter, it will be described in more detail with reference to the drawings. In the following drawings/description, the same reference numerals may represent the same or corresponding hardware blocks, software blocks, or functional blocks, unless otherwise indicated.

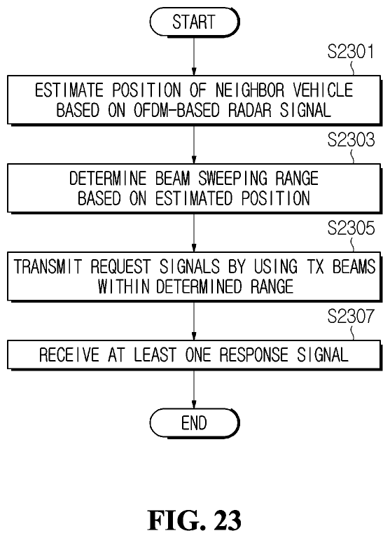

FIG. 24 illustrates a communication system, in accordance with an embodiment of the present disclosure. The embodiment of FIG. 24 may be combined with various embodiments of the present disclosure.

Referring to FIG. 24, the communication system applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include at least one of a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120a to 120e network may be implemented by a wireless device, and a specific wireless device 120a may operate as a base station/network node for another wireless device.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network through the base station 120. AI technology is applicable to the wireless devices 100a to 100f, and the wireless devices 100a to 100f may be connected to the AI server 100g through the network. The network may be configured using a 3G network, a 4G (e.g., LTE) network or a 5G (e.g., NR) network, etc. The wireless devices 100a to 100f may communicate with each other through the base stations 120a to 120e or perform direct communication (e.g., sidelink communication) without through the base stations 120a to 120e. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base stations 120a to 120e and the base stations 120a to 120e/the base stations 120a to 120e. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

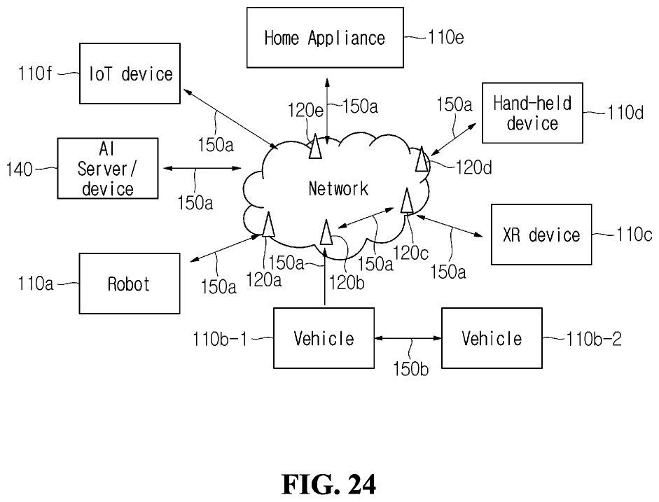

FIG. 25 illustrates wireless devices, in accordance with an embodiment of the present disclosure. The embodiment of FIG. 25 may be combined with various embodiments of the present disclosure.

Referring to FIG. 25, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 24.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may perform wireless communications with the first wireless device 200a and may include one or more processors 202b and one or more memories 204b and may further include one or more transceivers 206b and/or one or more antennas 208b. The functions of the one or more processors 202b, one or more memories 204b, one or more transceivers 206b, and/or one or more antennas 208b are similar to those of one or more processors 202a, one or more memories 204a, one or more transceivers 206a and/or one or more antennas 208a of the first wireless device 200a.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs), one or more service data unit (SDU), messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. In addition, one or more transceivers 206a and 206b may be coupled with one or more antennas 208a and 208b, and may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

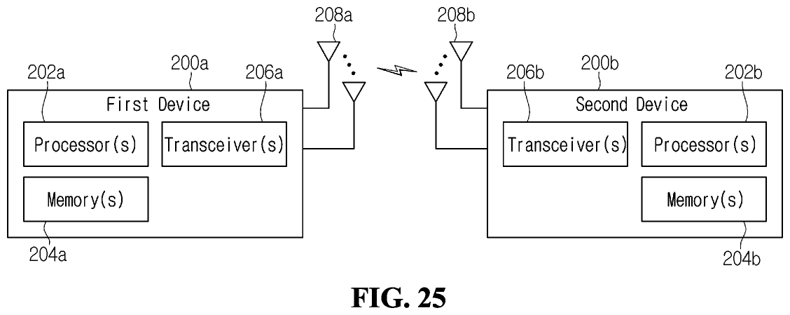

FIG. 26 illustrates a signal process circuit for a transmission signal, in accordance with an embodiment of the present disclosure. The embodiment of FIG. 26 may be combined with various embodiments of the present disclosure.

Referring to FIG. 26, a signal processing circuit 300 may include scramblers 310, modulators 320, a layer mapper 330, a precoder 340, resource mappers 350, and signal generators 360. For example, an operation/function of FIG. 26 may be performed by the processors 202a and 202b and/or the transceivers 36 and 206 of FIG. 25. Hardware elements of FIG. 26 may be implemented by the processors 202a and 202b and/or the transceivers 36 and 206 of FIG. 25. For example, blocks 310 to 360 may be implemented by the processors 202a and 202b of FIG. 25. Alternatively, the blocks 310 to 350 may be implemented by the processors 202a and 202b of FIG. 25 and the block 360 may be implemented by the transceivers 36 and 206 of FIG. 25, and it is not limited to the above-described embodiment.

Codewords may be converted into radio signals via the signal processing circuit 300 of FIG. 26. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH). Specifically, the codewords may be converted into scrambled bit sequences by the scramblers 310. Scramble sequences used for scrambling may be generated based on an initialization value, and the initialization value may include ID information of a wireless device. The scrambled bit sequences may be modulated to modulation symbol sequences by the modulators 320. A modulation scheme may include pi/2-Binary Phase Shift Keying (pi/2-BPSK), m-Phase Shift Keying (m-PSK), and m-Quadrature Amplitude Modulation (m-QAM).

Complex modulation symbol sequences may be mapped to one or more transport layers by the layer mapper 330. Modulation symbols of each transport layer may be mapped (precoded) to corresponding antenna port(s) by the precoder 340. Outputs z of the precoder 340 may be obtained by multiplying outputs y of the layer mapper 330 by an N*M precoding matrix W. Herein, N is the number of antenna ports and M is the number of transport layers. The precoder 340 may perform precoding after performing transform precoding (e.g., DFT) for complex modulation symbols. Alternatively, the precoder 340 may perform precoding without performing transform precoding.

The resource mappers 350 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 360 may generate radio signals from the mapped modulation symbols and the generated radio signals may be transmitted to other devices through each antenna. For this purpose, the signal generators 360 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures of FIG. 26. For example, the wireless devices (e.g., 200a and 200b of FIG. 25) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

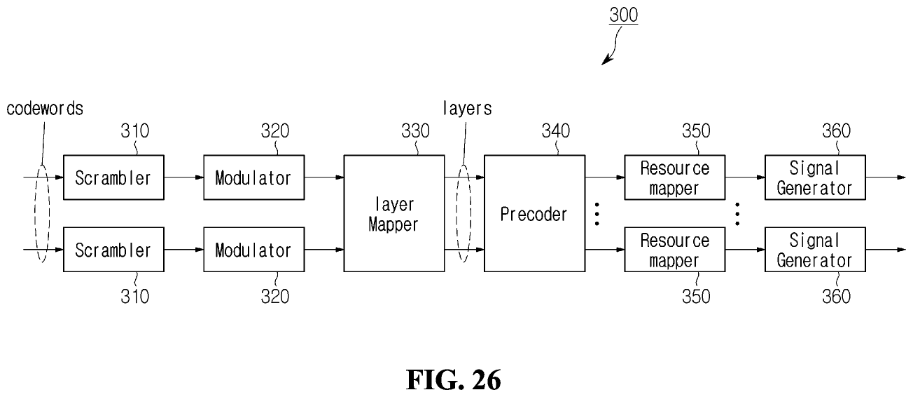

FIG. 27 illustrates a wireless device applicable to the present disclosure. The embodiment of FIG. 27 may be combined with various embodiments of the present disclosure.

Referring to FIG. 27, a wireless device 300 may correspond to the wireless devices 200a and 200b of FIG. 25 and include various elements, components, units/portions and/or modules. For example, the wireless device 300 may include a communication unit 310, a control unit (controller) 320, a memory unit (memory) 330 and additional components 340.

The communication unit 410 may include a communication circuit 412 and a transceiver(s) 414. The communication unit 410 may transmit and receive signals (e.g., data, control signals, etc.) to and from other wireless devices or base stations. For example, the communication circuit 412 may include one or more processors 202a and 202b and/or one or more memories 204a and 204b of FIG. 25. For example, the transceiver(s) 414 may include one or more transceivers 206a and 206b and/or one or more antennas 208a and 208b of FIG. 42.

The control unit 420 may be composed of at least one processor set. For example, the control unit 420 may be composed of a set of a communication control processor, an application processor, an electronic control unit (ECU), a graphic processing processor, a memory control processor, etc. The control unit 420 may be electrically coupled with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The memory unit 430 may be composed of a random access memory (RAM), a dynamic RAM (DRAM), a read only memory (ROM), a flash memory, a volatile memory, a non-volatile memory and/or a combination thereof. The memory unit 430 may store data/parameters/programs/codes/commands necessary to derive the wireless device 400. In addition, the memory unit 430 may store input/output data/information, etc.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 41, 100a), the vehicles (FIG. 41, 100b-1 and 100b-2), the XR device (FIG. 41, 100c), the hand-held device (FIG. 41, 100d), the home appliance (FIG. 41, 100e), the IoT device (FIG. 41, 100f), a digital broadcast terminal, a hologram apparatus, a public safety apparatus, an MTC apparatus, a medical apparatus, a Fintech device (financial device), a security device, a climate/environment device, an AI server/device (FIG. 41, 140), the base station (FIG. 41, 120), a network node, etc. The wireless device may be movable or may be used at a fixed place according to use example/service.

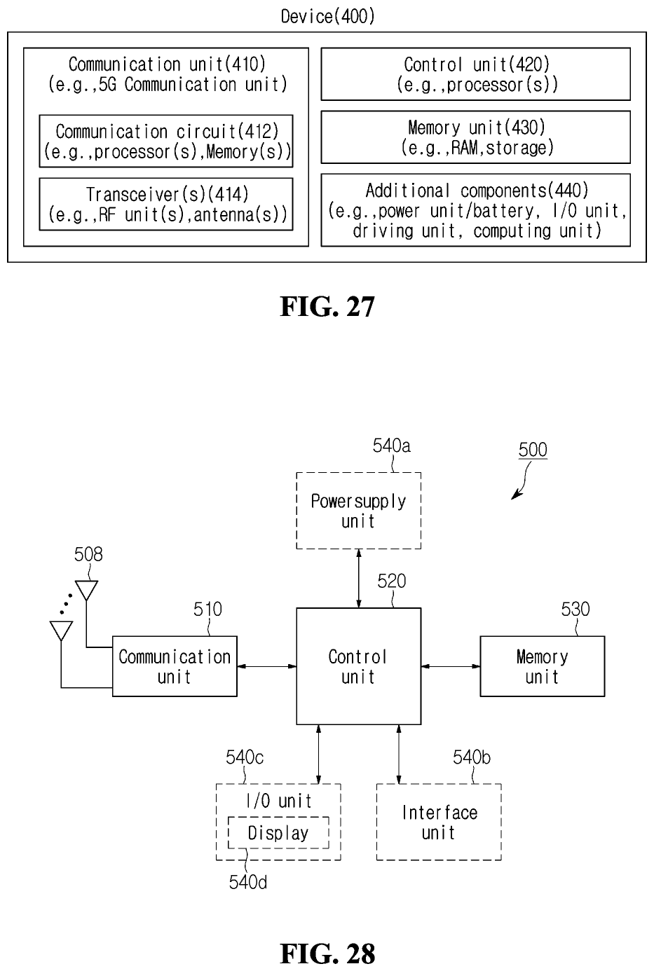

FIG. 28 illustrates a hand-held device applicable to the present disclosure. FIG. 28 exemplifies a hand-held device applicable to the present disclosure. The hand-held device may include a smartphone, a smart pad, a wearable device (e.g., a smart watch or smart glasses), and a hand-held computer (e.g., a laptop, etc.). The embodiment of FIG. 28 may be combined with various embodiments of the present disclosure.

Referring to FIG. 28, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/440a to 540c may correspond to the blocks 310 to 330/340 of FIG. 27, respectively, and duplicate descriptions are omitted.

The communication unit 510 may transmit and receive signals and the control unit 520 may control the hand-held device 500, and the memory unit 530 may store data and so on. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

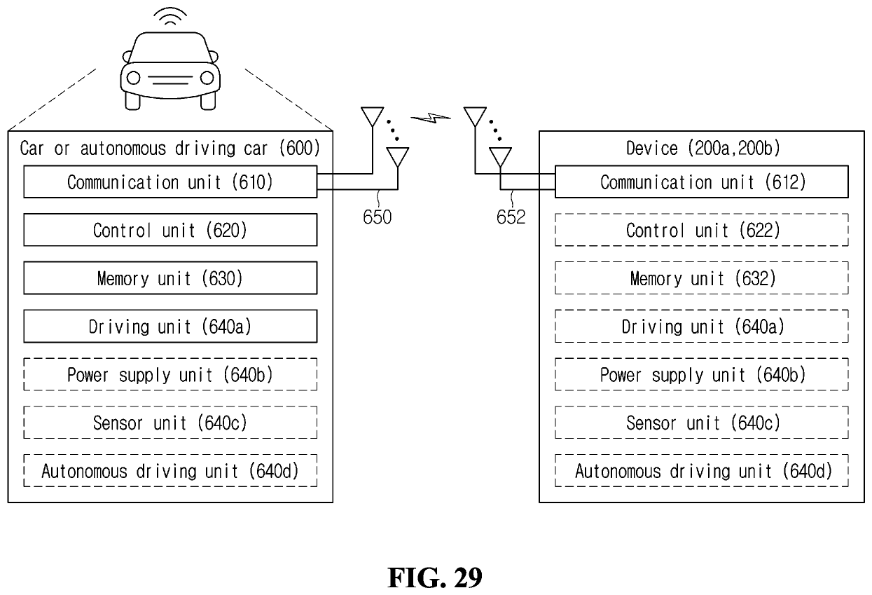

FIG. 29 illustrates a car or an autonomous vehicle applicable to the present disclosure. FIG. 29 exemplifies a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited. The embodiment of FIG. 29 may be combined with various embodiments of the present disclosure

Referring to FIG. 29, the car or autonomous driving car 600 may include an antenna unit (antenna) 608, a communication unit (transceiver) 610, a control unit (controller) 620, a driving unit 640a, a power supply unit (power supply) 640b, a sensor unit 640c, and an autonomous driving unit 640d. The antenna unit 650 may be configured as part of the communication unit 610. The blocks 610/630/640a to 640d correspond to the blocks 510/530/540 of FIG. 28, and duplicate descriptions are omitted.

The communication unit 610 may transmit and receive signals (e.g., data, control signals, etc.) to and from external devices such as another vehicle, a base station (e.g., a base station, a road side unit, etc.), and a server. The control unit 620 may control the elements of the car or autonomous driving car 600 to perform various operations. The control unit 620 may include an electronic control unit (ECU). The driving unit 640a may drive the car or autonomous driving car 600 on the ground. The driving unit 640a may include an engine, a motor, a power train, wheels, a brake, a steering device, etc. The power supply unit 640b may supply power to the car or autonomous driving car 600, and include a wired/wireless charging circuit, a battery, etc. The sensor unit 640c may obtain a vehicle state, surrounding environment information, user information, etc. The sensor unit 640c may include an inertial navigation unit (IMU) sensor, a collision sensor, a wheel sensor, a speed sensor, an inclination sensor, a weight sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, a brake pedal position sensor, and so on. The autonomous driving sensor 640d may implement technology for maintaining a driving lane, technology for automatically controlling a speed such as adaptive cruise control, technology for automatically driving the car along a predetermined route, technology for automatically setting a route when a destination is set and driving the car, etc.

For example, the communication unit 610 may receive map data, traffic information data, etc. from an external server. The autonomous driving unit 640d may generate an autonomous driving route and a driving plan based on the acquired data. The control unit 620 may control the driving unit 640a (e.g., speed/direction control) such that the car or autonomous driving car 600 moves along the autonomous driving route according to the driving plane. During autonomous driving, the communication unit 610 may aperiodically/periodically acquire latest traffic information data from an external server and acquire surrounding traffic information data from neighboring cars. In addition, during autonomous driving, the sensor unit 640c may acquire a vehicle state and surrounding environment information. The autonomous driving unit 640d may update the autonomous driving route and the driving plan based on newly acquired data/information. The communication unit 610 may transmit information such as a vehicle location, an autonomous driving route, a driving plan, etc. to the external server. The external server may predict traffic information data using AI technology or the like based on the information collected from the cars or autonomous driving cars and provide the predicted traffic information data to the cars or autonomous driving cars.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method for operating a terminal in a wireless communication system, the method comprising:
generating sequences for signals;
mapping complex symbols in the sequences to resource elements (REs) that are allocated for the signals;
generating orthogonal frequency division multiplexing (OFDM) symbols including the complex symbols; and
transmitting OFDM symbols,
wherein the signals comprise chirp signals where adjacent chirp signals of the chirp signals are at least partly overlapped on a time axis.

2. The method of claim 1, further comprising:
receiving echo signals that are the chirp signals reflected by a neighbor vehicle;
canceling, for each of the echo signals, interference caused by an adjacent echo signal; and
estimating at least one of a distance to the neighbor vehicle, a direction for the neighbor vehicle, and a moving velocity of the neighbor vehicle by using the interference-cancelled echo signals.

3. The method of claim 1, further comprising:
determining a direction for a neighbor vehicle by using echo signals that are received after the chirp signals are reflected by the neighbor vehicle;
determining, based on the direction, a spatial domain filter sweeping range for spatial domain filter alignment with a terminal in the neighbor vehicle; and
performing spatial domain filter alignment by using a plurality of transmission spatial domain filters that belong to the spatial domain filter sweeping range.

4. The method of claim 1, wherein each of the sequences has a bandwidth of 12 resource blocks (RBs).

5. The method of claim 1, wherein REs allocated for each of the sequences include one RE per RB.

6. The method of claim 1, wherein an interval between the adjacent chirp signals is half of a time axis length of a single chirp signal.

7. The method of claim 1, wherein a slope on frequency-time axes of the sequences and a number of REs allocated to each sequence are determined based on a communication environment of the terminal.

8. (canceled)

9. A communication device comprising:
at least one processor; and
at least one computer memory that is coupled to the at least one processor and stores an instruction instructing operations when being executed by the at least one processor, wherein the operations comprises:
generating sequences for signals;
mapping complex symbols in the sequences to resource elements (REs) that are allocated for the signals;
generating orthogonal frequency division multiplexing (OFDM) symbols including the complex symbols; and
transmitting OFDM symbols, and
wherein the signals comprise chirp signals where adjacent chirp signals of the chirp signals are at least partly overlapped on a time axis.

10. (canceled)

11. A terminal in a wireless communication system, the terminal comprising:
a transceiver; and
a processor coupled to the transceiver and configured to:
generate sequences for signals,
map complex symbols in the sequences to resource elements (REs) that are allocated for the signals,
generate orthogonal frequency division multiplexing (OFDM) symbols including the complex symbols, and
transmit OFDM symbols,
wherein the signals comprise chirp signals where adjacent chirp signals of the chirp signals are at least partly overlapped on a time axis.

12. The terminal of claim 11, wherein the processor is further configured to:
receiving echo signals that are the chirp signals reflected by a neighbor vehicle;
canceling, for each of the echo signals, interference caused by an adjacent echo signal; and
estimating at least one of a distance to the neighbor vehicle, a direction for the neighbor vehicle, and a moving velocity of the neighbor vehicle by using the interference-cancelled echo signals.

13. The terminal of claim 11, wherein the processor is further configured to:
determining a direction for a neighbor vehicle by using echo signals that are received after the chirp signals are reflected by the neighbor vehicle;
determining, based on the direction, a spatial domain filter sweeping range for spatial domain filter alignment with a terminal in the neighbor vehicle; and
performing spatial domain filter alignment by using a plurality of transmission spatial domain filters that belong to the spatial domain filter sweeping range.

14. The terminal of claim 11, wherein each of the sequences has a bandwidth of 12 resource blocks (RBs).

15. The terminal of claim 11, wherein REs allocated for each of the sequences include one RE per RB.

16. The terminal of claim 11, wherein an interval between the adjacent chirp signals is half of a time axis length of a single chirp signal.

17. The terminal of claim 11, wherein a slope on frequency-time axes of the sequences and a number of REs allocated to each sequence are determined based on a communication environment of the terminal.
